(19) United States
(12) Patent Application Publication
(10) Pub. No.: US 2024/0155598 A1
(43) Pub. Date: May 9, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/412,631

(22) Filed: Jan. 15, 2024

Related U.S. Application Data
(63) Continuation of application No. PCT/CN2022/104050, filed on Jul. 6, 2022.

(30) Foreign Application Priority Data
Jul. 16, 2021 (CN) 202110803860.9
Aug. 4, 2021 (CN) 202110889885.5

(51) Int. Cl. H04W 72/11; H04L 1/00; H04W 72/0453

(52) U.S. Cl. CPC H04W 72/11; H04L 1/0003; H04W 72/0453

(57) ABSTRACT

A node firstly receives a first signaling and a second signaling, the first signaling is used to indicate an SPS configuration, the second signaling is used to provide a downlink assignment for the SPS configuration; then receives a first signal in a first time unit; the first time unit is occupied by a Y-th downlink assignment after the downlink assignment is configured; the first signal is obtained after a first bit block is subjected to at least channel coding and modulation; a number of bit(s) comprised in the first bit block is related to the Y. The present application is for SPS configuration and transmission, to adjust the transport block size according to a location of the downlink assignment in the entire SPS transmission, and thus to adapt to the different needs of different communication services with respect to the period as well as the data arrival rate.

### CROSS REFERENCE TO RELATED APPLICATIONS

This application is the continuation of the international patent application No. PCT/CN2022/104050, filed on Jul. 6, 2022, and claims the priority benefit of Chinese Patent Application No. 202110803860.9, filed on Jul. 16, 2021, and claims the priority benefit of Chinese Patent Application No. 202110889885.5, filed on Aug. 4, 2021, the full disclosure of which is incorporated herein by reference.

### BACKGROUND

### Technical Field

The present application relates to transmission methods and devices in wireless communication systems, and in particular to a design scheme and device under semi-persistent scheduling in wireless communications.

### Related Art

The application of new technologies such as artificial intelligence (AI) in the field of communications has attracted increasing attention. In RAN1 #103e, the XR topic has been discussed in 3GPP to address the different application scenarios and requirements brought by future AI. Periodicity specific to the XR field, such as 1/60th of a second, which approximates 16.67 ms (milliseconds), was discussed at RAN1 #105e meeting. Currently, for traditional Semi-Persistent Scheduling (SPS) services, periods used are often designed based on the existing 3GPP frame structure periods, such as 10 ms, 20 ms, 32 ms, 40 ms, and other different period configurations, and the above period configurations are not compatible with the requirements of XR. Furthermore, the above issues need to be addressed in subsequent discussions.

### SUMMARY

A relatively simple solution to the above problem is to design a cycle-specific SPS configuration specifically for XR, such as 16.67 ms as the cyclic SPS configuration. However, such an approach leads to the fact that the SPS designed for XR cannot be multiplexed with other conventional SPSs in time domain, which in turn leads to fragmentation of resources and affects the overall scheduling performance of the system.

To address the above problem, the present application provides a solution. It should be noted that although the above description uses XR communication scenarios as an example, the present application is also applicable to other non-XR communication scenarios, where similar technical effects can be achieved. Additionally, the adoption of a unified solution for various scenarios, including but not limited to XR communication scenarios, contributes to the reduction of hardware complexity and costs. Meanwhile, although the above description uses SPS as an example, the present application is also applicable to other non-SPS communication scenarios, where similar technical effects can be achieved. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

To solve the above problems, the present application discloses a design method and device for transmission of a control channel and a data channel under the SPS scenario. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict. Though originally targeted at cellular network, the present application is also applicable to Internet of Things (IoT) and Internet of Vehicles (IoV). Though originally targeted at SPS scenarios, the present application is also applicable to non-SPS scenarios. Though originally targeted at multi-antenna communications, the present application is also applicable to single-antenna communications. Besides, the present application is not only targeted at scenarios of terminals and base stations, but also at communication scenarios between terminals and terminals, terminals and relays, Non-Terrestrial Networks as well as relays and base stations, where similar technical effects can be achieved. Additionally, the adoption of a unified solution for various scenarios, including but not limited to communication scenarios between terminals and base stations, contributes to the reduction of hardware complexity and costs.

Further, embodiments of a first node in the present application and the characteristics of the embodiments may be applied to a second node if no conflict is incurred, and vice versa. Particularly, for interpretations of the terminology, nouns, functions and variants (if not specified) in the present application, refer to definitions given in Technical Specification (TS) 36 series, TS 38 series and TS 37 series of 3GPP specifications.

The present application provides a method in a first node for wireless communications, comprising:
receiving a first signaling and a second signaling, the first signaling being used to indicate an SPS configuration, the second signaling being used to provide a downlink assignment for the SPS configuration; and
receiving a first signal in a first time unit;
herein, the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, one technical feature of the above method is in: in conventional SPS, frequency-domain resources and Modulation and Coding Scheme (MCS) occupied by data transmitted by the terminal in each downlink assignment, i.e., each Physical Downlink Shared Channel (PDSCH), in an SPS configuration are the same to reflect the periodicity characteristics; with the scheme proposed in the present application, frequency-domain resources or MCS occupied by individual downlink assignment in an SPS configuration are related to a location of the downlink assignment in the overall SPS transmission, and thus the flexibility of the transmission is reflected in an SPS configuration.

In one embodiment, another technical feature of the above method is in: on the basis of ensuring that the period of the existing SPS is followed, by adjusting a number of bits actually transmitted on different downlink assignments in one SPS configuration period, the feature of satisfying a transmission period of 16.67 ms is thereby achieved to cope with the demands of XR.

According to one aspect of the present application, the second signaling is used to indicate an SPS activation; the second signaling is used to determine frequency-domain resources occupied by the first signal.

According to one aspect of the present application, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, another technical feature of the above method is in: on the basis of ensuring that the period of the existing SPS is followed, only a number of REs actually occupied on different downlink assignments in one SPS configuration period is adjusted without changing the MCS, the feature of satisfying a transmission period of 16.67 ms is thereby achieved to cope with the demands of XR.

According to one aspect of the present application, at least one of coding rate adopted by the channel coding to which the first bit block is subjected or a modulation order adopted by the modulation to which the first bit block is subjected is related to the Y.

In one embodiment, another technical feature of the above method is in: on the basis of ensuring that the cycle of the existing SPS is followed, only the MCSs actually adopted on different downlink assignments in one SPS configuration cycle are adjusted without changing a number of occupied REs, thus realizing the feature of meeting the transmission cycle of 16.67 ms to cope with the needs of XR.

According to one aspect of the present application, the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

According to one aspect of the present application, the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, one technical feature of the above method is in: a PDSCH transmitted in a time unit in the first time unit set adopts one Transport Block Size (TBS) and a PDSCH transmitted in a time unit of the second time unit set adopts another TBS; thereby achieving a transmission rate not achievable with one existing SPS configuration cycle for a transmission of the entire SPS configuration covering the first time unit set and the second time unit set.

According to one aspect of the present application, the first signaling is used to determine at least one of the first time unit set or the second time unit set.

According to one aspect of the present application, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, one technical feature of the above method is in: further establishing an association between different service requirements in XR scenarios with multiple MCSs employed in an SPS configuration to further increase the flexibility and adaptability of the SPS.

The present application provides a method in a second node for wireless communications, comprising:
transmitting a first signaling and a second signaling, the first signaling being used to indicate an SPS configuration, the second signaling being used to provide a downlink assignment for the SPS configuration; and
transmitting a first signal in a first time unit;
herein, the first time unit is occupied by a Y-th downlink assignment after the downlink assignment is configured; the first signal is obtained after a first bit block is subjected to at least channel coding and modulation; a number of bit(s) comprised in the first bit block is related to the Y.

According to one aspect of the present application, the second signaling is used to indicate an SPS activation; the second signaling is used to determine frequency-domain resources occupied by the first signal.

According to one aspect of the present application, coding rate adopted by the channel coding to which the first bit block is subjected and a modulation order adopted by the modulation to which the first bit block is subjected are unrelated to Y; a number of RE(s) occupied by the first signal is related to the Y.

According to one aspect of the present application, at least one of coding rate adopted by the channel coding to which the first bit block is subjected or a modulation order adopted by the modulation to which the first bit block is subjected is related to the Y.

According to one aspect of the present application, the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

According to one aspect of the present application, the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

According to one aspect of the present application, the first signaling is used to determine at least one of the first time unit set or the second time unit set.

According to one aspect of the present application, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

The present application provides a first node for wireless communications, comprising:
a first receiver, receiving a first signaling and a second signaling, the first signaling being used to indicate an SPS configuration, the second signaling being used to provide a downlink assignment for the SPS configuration; and
the second receiver, receiving a first signal in a first time unit;
herein, the first time unit is occupied by a Y-th downlink assignment after the downlink assignment is configured; the first signal is obtained after a first bit block is subjected to at least channel coding and modulation; a number of bit(s) comprised in the first bit block is related to the Y.

The present application provides a second node for wireless communications, comprising:
a first transmitter, transmitting a first signaling and a second signaling, the first signaling being used to indicate an SPS configuration, the second signaling being used to provide a downlink assignment for the SPS configuration; and
a second transmitter, transmitting a first signal in a first time unit;
herein, the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the present application has the following advantages over conventional schemes:
in conventional SPS, frequency-domain resources and MCS occupied by data transmitted by the terminal in each downlink assignment, i.e., each PDSCH, of an SPS configuration are the same to reflect the periodicity characteristics; with the scheme proposed in the present application, frequency-domain resources or MCS occupied by individual downlink assignment in an SPS configuration are related to a location of the downlink assignment in the overall SPS transmission, and thus the flexibility of the transmission is reflected in an SPS configuration;
on the basis of ensuring that the period of the existing SPS is followed, by adjusting a number of bits actually transmitted on different downlink assignments in an SPS configuration period, the feature of satisfying a transmission period of 16.67 ms is thereby achieved to cope with the demands of XR; the above mentioned way of adjusting a number of transmitted bits can be based on adjusting the MCS, or on adjusting a number of REs actually occupied;
further establishing an association between different service requirements in XR scenarios with multiple MCSs employed in an SPS configuration or multiple RE numbers to further increase the flexibility and adaptability of the SPS.

The present application provides a method in a first node for wireless communications, comprising:
receiving a first signaling, the first signaling being used to indicate a configuration of configured grant; and
transmitting a first signal in a first time unit;
herein, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is a Radio Resource Control (RRC) signaling, the first signaling is used to indicate a number of Hybrid Automatic Repeat reQuest (HARQ) process(es) of the configured grant; Y is a positive integer.

In one embodiment, one technical feature of the above method is in: in conventional uplink free Dynamic Grant transmission, frequency-domain resources and MCS occupied by data transmitted by the terminal in each uplink grant of a configured grant, i.e., each PUSCH, are the same to reflect the periodicity characteristics; with the scheme presented in the present application, frequency-domain resources or MCS occupied by a data channel corresponding to the individual uplink grants in a configured grant are related to a location of the uplink grant in the transmission of the entire configured grant, which in turn embodies transmission flexibility in a single configured grant.

In one embodiment, another technical feature of the above method is in: on the basis of ensuring that the existing period of the configured grant is followed, by adjusting a number of bits actually transmitted in different uplink grants in a configuration period of a configured grant, and thus achieving the feature of meeting the transmission period of 16.67 ms to cope with the needs of XR.

According to one aspect of the present application, comprising:
receiving a second signaling;
herein, a CRC comprised in the second signaling is scrambled by a first Radio Network Temporary Identifier (RNTI); the second signaling is used to indicate that the configured grant indicated by the first signaling is activated; the second signaling is a physical-layer signaling; the first RNTI is an RNTI other than a Cell Radio Network Temporary Identifier (C-RNTI).

According to one aspect of the present application, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, one technical feature of the above method is in: on the basis of guaranteeing to follow the existing period of the configured grant, only a number of REs actually occupied by different uplink grants in a configuration period of a configured grant is adjusted without changing the MCS, thus realizing the feature of meeting the transmission period of 16.67 ms to cope with the needs of XR.

According to one aspect of the present application, at least one of coding rate adopted by the channel coding to which the first bit block is subjected or a modulation order adopted by the modulation to which the first bit block is subjected is related to the Y.

In one embodiment, one technical feature of the above method is in: on the basis of guaranteeing to follow the existing period of the configured grant, only an MCS actually used in different uplink grants in a configuration period of a configured grant are adjusted without changing a number of occupied REs, thus realizing the feature of meeting the transmission period of 16.67 ms to cope with the needs of XR.

According to one aspect of the present application, the first signaling is used to determine a first MCS table and the second signaling is used to indicate a target MCS index from the first MCS table, or the first signaling is used to indicate a target MCS index; the target MCS index and Y are used together to determine at least one of coding rate adopted by the channel coding to which the first bit block is subjected or a modulation order adopted by the modulation to which the first bit block is subjected.

According to one aspect of the present application, the first signaling is used to indicate a first configured grant configuration index, and a period of a configured grant corresponding to the first configured grant configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, one technical feature of the above method is in: a PUSCH transmitted in a time unit in the first time unit set adopts one Transport Block Size (TBS), while a PDSCH transmitted in a time unit in the second time unit set adopts another TBS; in turn, it is achieved that a transmission rate not achievable with a cycle configured by the existing configured grant is realized in a transmission of the first time unit set and the second time unit set covered by the entire configured grant.

According to one aspect of the present application, the first signaling is used to determine at least one of the first time unit set or the second time unit set.

According to one aspect of the present application, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, one technical feature of the above method is in: further establishing a connection between different service requirements in XR scenarios and multiple MCSs adopted in a configured grant to further increase the flexibility and adaptability of non-dynamic grant transmission.

The present application provides a method in a second node for wireless communications, comprising:
transmitting a first signaling, the first signaling being used to indicate a configuration of configured grant; and
receiving a first signal in a first time unit;
herein, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

According to one aspect of the present application, comprising:
transmitting a second signaling;
herein, a CRC comprised in the second signaling is scrambled through a first RNTI; the second signaling is used to indicate that the configured grant indicated by the first signaling is activated; the second signaling is a physical-layer signaling; the first RNTI is an RNTI other than a C-RNTI;
According to one aspect of the present application, coding rate adopted by the channel coding to which the first bit block is subjected and a modulation order adopted by the modulation to which the first bit block is subjected are unrelated to Y; a number of RE(s) occupied by the first signal is related to the Y.

According to one aspect of the present application, at least one of coding rate adopted by the channel coding to which the first bit block is subjected or a modulation order adopted by the modulation to which the first bit block is subjected is related to the Y.

According to one aspect of the present application, the first signaling is used to determine a first MCS table and the second signaling is used to indicate a target MCS index from the first MCS table, or the first signaling is used to indicate a target MCS index; the target MCS index and Y are used together to determine at least one of coding rate adopted by the channel coding to which the first bit block is subjected or a modulation order adopted by the modulation to which the first bit block is subjected.

According to one aspect of the present application, the first signaling is used to indicate a first configured grant configuration index, and a period of a configured grant corresponding to the first configured grant configuration index is used to determine a first time unit set and a second time unit set; both the first time unit set and the second time unit set comprise positive integer number of time units greater than 1; the first time unit set comprises the first time unit or the second time unit set comprises the first time unit.

According to one aspect of the present application, the first signaling is used to determine at least one of the first time unit set or the second time unit set.

According to one aspect of the present application, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

The present application provides a first node for wireless communications, comprising:
a first receiver, receiving a first signaling, the first signaling being used to indicate a configuration of configured grant; and
the first transmitter, transmitting a first signal in a first time unit;
herein, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

The present application provides a second node for wireless communications, comprising:
a second transmitter, transmitting a first signaling, the first signaling being used to indicate a configuration of configured grant; and
the second receiver, receiving a first signal in a first time unit;
herein, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the present application has the following advantages over conventional schemes:
in conventional configured grant, the terminal occupies same frequency-domain resources and MCS for data transmissions corresponding to each uplink grant of a configured grant, i.e., data transmitted in each PUSCH, to reflect the periodicity characteristics; with the scheme presented in the present application, frequency-domain resources or MCS occupied by individual uplink grant in a configured grant are related to a location of the uplink grant in the entire configured grant transmission, which in turn embodies the transmission flexibility in a single configured grant configuration;
on the basis of guaranteeing to follow the existing period of the configured grant, by adjusting a number of bits actually transmitted in different uplink grants in a configuration period of a configured grant, and thus realizing the characteristic of meeting the transmission period of 16.67 ms to cope with the needs of XR; the above mentioned way of adjusting a number of transmitted bits can be based on adjusting the MCS, or on adjusting a number of REs actually occupied;
further establishing an association between different service requirements in XR scenarios with multiple MCSs employed in a configured grant or multiple RE numbers to further increase the flexibility and adaptability of the configured grant.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of the processing of a first node according to one embodiment of the present application;

FIG. 1B illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of a first signaling according to one embodiment of the present application;

FIG. 5B illustrates a flowchart of a first signaling according to one embodiment of the present application;

FIG. 6A illustrates a schematic diagram of a first time unit according to one embodiment of the present application;

FIG. 6B illustrates a schematic diagram of a first time unit according to one embodiment of the present application;

FIG. 7A illustrates a schematic diagram of a downlink assignment according to one embodiment of the present application;

FIG. 7B illustrates a schematic diagram of a first time unit according to another embodiment of the present application;

FIG. 8A illustrates a schematic diagram of a downlink assignment according to another embodiment of the present application;

FIG. 8B illustrates a schematic diagram of an uplink grant according to one embodiment of the present application;

FIG. 9A illustrates a schematic diagram of a first time unit set and a second time unit set according to one embodiment of the present application;

FIG. 9B illustrates a schematic diagram of an uplink grant according to another embodiment of the present application;

FIG. 10A illustrates a schematic diagram of a first time unit set and a second time unit set according to another embodiment of the present application;

FIG. 10B illustrates a schematic diagram of a first time unit set and a second time unit set according to one embodiment of the present application;

FIG. 11A illustrates a structure block diagram of a processor in a first node according to one embodiment of the present application;

FIG. 11B illustrates a schematic diagram of a first time unit set and a second time unit set according to another embodiment of the present application;

FIG. 12A illustrates a structure block diagram of a processor in second node according to one embodiment of the present application;

FIG. 12B illustrates a structure block diagram of a processor in a first node according to one embodiment of the present application;

FIG. 13 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

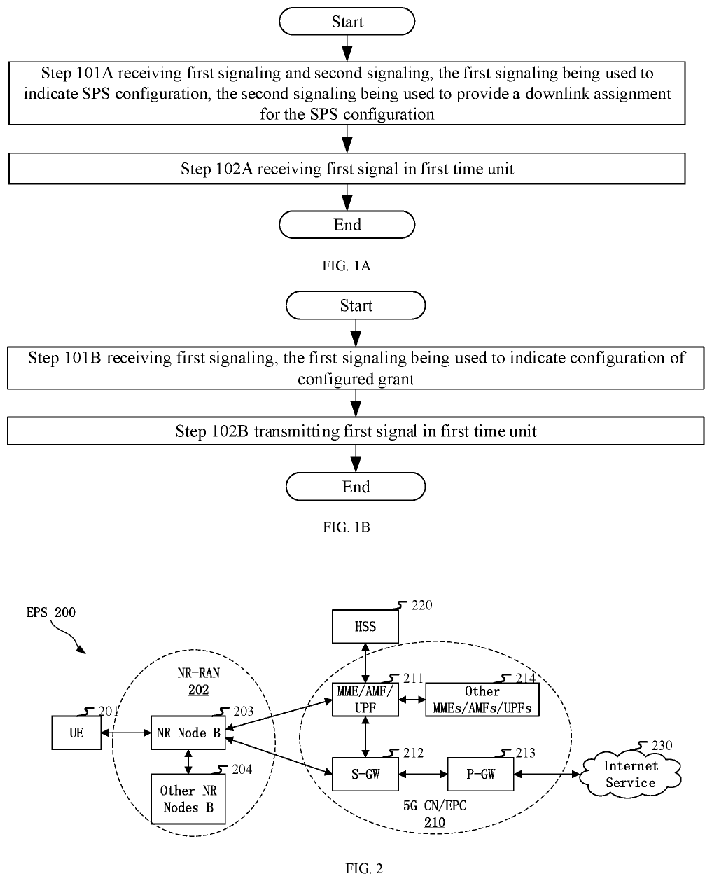

Embodiment 1A illustrates flowchart of the processing of a first node, as shown in FIG. 1A. In step 100A illustrated by FIG. 1A, each box represents a step. In embodiment 1A, a first node in the present application receives a first signaling and a second signaling in step 101A, the first signaling is used to indicate an SPS configuration, and the second signaling is used to provide a downlink assignment for the SPS configuration; receives a first signal in a first time unit in step 102A.

In embodiment 1A, the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the SPS configuration is an SPS Configuration.

In one embodiment, the SPS configuration corresponds to an SPS-ConfigIndex.

In one embodiment, SPS-ConfigIndex corresponding to the SPS configuration is a non-negative integer.

In one embodiment, the first signaling is used to indicate an SPS-ConfigIndex.

In one embodiment, the first signaling is used to indicate a Configured Scheduling Radio Network Temporary Identifier (CS-RNTI).

In one embodiment, the first signaling is used to indicate nrofHARQ-Processes.

In one embodiment, the first signaling is used to indicate harq-ProcID-Offset.

In one embodiment, the first signaling is used to indicate a periodicity of the downlink assignment configured for an SPS.

In one embodiment, the first signaling is a Radio Resource Control (RRC) signaling.

In one embodiment, the first signaling is an SPS-Configure IE in Technical Specification (TS) 38.331.

In one embodiment, the downlink assignment is a Downlink Assignment.

In one embodiment, the second signaling is Downlink control information (DCI).

In one embodiment, a physical-layer channel occupied by the second signaling comprises a Physical Downlink Control Channel (PDCCH).

In one embodiment, a CRC comprised by the second signaling is scrambled through a CS-RNTI.

In one embodiment, the second signaling is used for an activation of the SPS configuration.

In one embodiment, the first node validates that SPS transmission targeted by the SPS configuration is activated based on a reception of the second signaling.

In one embodiment, the first time unit is a slot.

In one embodiment, the first time unit occupies a positive integer number of more than one continuous Orthogonal Frequency Division Multiplexing (OFDM) symbols.

In one embodiment, the time unit in the present application is a slot.

In one embodiment, the time unit in the present application occupies a positive integer number of more than 1 continuous OFDM symbols.

In one embodiment, a DCI format adopted by the second signaling is one of 1_0, 1_1 or 1_2.

In one embodiment, the first signal is a radio signal.

In one embodiment, the first signal is a baseband signal.

In one embodiment, the first signal is generated by a Transport Block (TB).

In one embodiment, the first signal is generated by a Code Block (CB).

In one embodiment, the first signal is generated by a Code Block Group (CBG).

In one embodiment, the first bit block is generated by a TB.

In one embodiment, the first bit block is generated by a CB.

In one embodiment, the first bit block is generated by a CBG.

In one embodiment, a physical-layer channel occupied by the first signal comprises a PDSCH.

In one embodiment, a transport channel occupied by the first signal comprises a Downlink Shared Channel (DL-SCH).

In one embodiment, the first signaling is used to determine a first time unit pool, the first time unit pool comprises K1 time units, K1 being a positive integer greater than 1, and the first time unit is a time unit in the first time unit pool.

In one subembodiment of the embodiment, any of the K1 time units is a slot.

In one subembodiment of the above embodiment, any of the K1 time units occupies more than one positive integer number of continuous OFDM symbols.

In one subembodiment of the above embodiment, the second signaling is used to determine a target time unit set, the target time unit set comprises K2 time units, any of the K2 time units belongs to the first time unit pool, and the target time unit is one of the K2 time units.

In one subsidiary embodiment of the subembodiment, the second signaling is used to determine an earliest time unit located in time domain among the K2 time units.

In one subsidiary embodiment of the subembodiment, the first time unit is a Y-th time unit among the K2 time units.

In one subsidiary embodiment of the subembodiment, the first time unit is a (Y−1)-th time unit among the K2 time units.

In one subsidiary embodiment of the subembodiment, a time unit where the second signaling is located is a first one of time units among the K2 time units.

In one embodiment, Y is a positive integer.

In one embodiment, Y is a non-negative integer.

In one embodiment, the first signal is obtained after the first bit block is through at least CRC attachment, Code Block Segmentation, Per-CB CRC Attachment, channel encoding, Rate Matching and CB Concatenation.

In one embodiment, the first signal is obtained after the first bit block is through at least CRC attachment, channel encoding and rate matching.

In one embodiment, the first signal is obtained after the first bit block is through at least Scrambling, the Modulation and resource mapping.

In one embodiment, the first signal is obtained after the first bit block is through scrambling, the modulation operation, layer mapping, antenna port mapping and resource block mapping.

In one embodiment, the first signal is obtained after the first bit block is through CRC attachment, Code Block Segmentation, Per-CB CRC Attachment, channel encoding, rate matching and CB Concatenation.

In one embodiment, the first signal is obtained after the first bit block is through CRC attachment, channel encoding and rate matching.

In one embodiment, the first signal is obtained after the first bit block is through scrambling, the modulation operation and resource block mapping.

In one embodiment, the first signal is obtained after the first bit block is through scrambling, the modulation operation, layer mapping, antenna port mapping and resource block mapping.

In one embodiment, the first signal is obtained after the first bit block is sequentially through CRC attachment, Code Block Segmentation, Per-CB CRC Attachment, channel encoding, rate matching and CB Concatenation.

In one embodiment, the first signal is obtained after the first bit block is through channel coding, then is sequentially through scrambling, modulation operation, layer mapping, antenna port mapping and resource block mapping.

In one embodiment, the resource block mapping comprises mapping to an RE other than an assigned RE in a physical resource block.

In one embodiment, the resource block mapping comprises mapping to Virtual Resource Block and mapping from Virtual Resource Block to a physical resource block.

In one embodiment, the channel coding is based on a Low-density Parity-Check (LDPC) code.

In one embodiment, the channel coding is based on Turbo code.

In one embodiment, the channel coding is based on polar code.

In one embodiment, a Hybrid Automatic Repeat reQuest (HARQ) Process Number field comprised in the second signaling is set as full “0”.

In one embodiment, a Redundancy Version field comprised in the second signaling is set as full “0”.

### Embodiment 1B

Embodiment 1B illustrates a flowchart of the processing of a first node, as shown in FIG. 1B. In step 100B illustrated by FIG. 1B, each box represents a step. In Embodiment 1B, the first node in the present application receives a first signaling in step 101B, the first signaling is used to indicate a configuration of configured grant; transmits a first signal in a first time unit in step 102B.

In embodiment 1B, the first time unit is occupied by a given uplink grant, the given uplink grant is a Y-th uplink grant after the configured grant indicated by the first signaling is configured configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the first signaling is an RRC signaling.

In one embodiment, a name of the first signaling comprises ConfiguredGrant.

In one embodiment, a name of the first signaling comprises Config.

In one embodiment, the first signaling is transmitted through a ConfiguredGrantConfig Information Element (IE) in TS 38.331.

In one embodiment, a physical-layer channel occupied by the first signaling comprises a Physical Downlink Shared Channel (PDSCH).

In one embodiment, the configured grant is a Configured Grant.

In one embodiment, a configured grant indicated by the first signaling is Type 1 configured grant.

In one embodiment, a configured grant indicated by the first signaling is Type 2 configured grant.

In one embodiment, the first signaling is used to indicate a Periodicity of the configured grant.

In one embodiment, the first signaling is used to determine a transmit power value of the first signal.

In one subembodiment of the above embodiment, the first signaling is used to indicate a first coefficient, and the first coefficient is used to determine the transmit power value of the first signal.

In one subsidiary embodiment of the subembodiment, the first coefficient corresponds to p0-PUSCH-Alpha in TS 38.331.

In one subembodiment of the above embodiment, the first signaling is used to indicate a pathloss reference index, and the pathloss reference index is used to determine the transmit power value of the first signal.

In one subsidiary embodiment of the subembodiment, the pathloss reference index corresponds to pathlossReferenceIndex in TS 38.331.

In one embodiment, the first signaling is used to determine the first time unit.

In one embodiment, the first time unit is a slot.

In one embodiment, the first time unit occupies at least one symbol in time domain.

In one embodiment, the first time unit occupies multiple continuous symbols in time domain.

In one embodiment, the time unit in the present application is a slot.

In one embodiment, the time unit in the present application occupies at least one symbol.

In one embodiment, the time unit in the present application occupies multiple continuous symbols in time domain.

In one embodiment, the symbol in the present application is an Orthogonal Frequency Division Multiplexing (OFDM) symbol.

In one embodiment, the symbol in the present application is a Single Carrier-Frequency Division Multiple Access (SC-FDMA) symbol.

In one embodiment, the symbol in the present application is a Filter Bank Multi Carrier (FBMC) symbol.

In one embodiment, the symbol in the present application is an PFDM symbol comprising a Cyclic Prefix (CP).

In one embodiment, the symbol in the present application is a Discrete Fourier Transform Spreading Orthogonal Frequency Division Multiplexing (DFT-s-OFDM) symbol comprising a CP.

In one embodiment, the first signal is a radio signal.

In one embodiment, the first signal is a baseband signal.

In one embodiment, the first signal is generated by a Transport Block (TB).

In one embodiment, the first signal is generated by a Code Block (CB).

In one embodiment, the first signal is generated by a Code Block Group (CBG).

In one embodiment, the first bit block is generated by a TB.

In one embodiment, the first bit block is generated by a CB.

In one embodiment, the first bit block is generated by a CBG.

In one embodiment, a physical-layer channel occupied by the first signal comprises a PUSCH.

In one embodiment, a transport channel occupied by the first signal comprises an Uplink Shared Channel (UL-SCH).

In one embodiment, the first signaling is used to determine a first time unit pool, the first time unit pool comprises K1 time units, K1 being a positive integer greater than 1, and the first time unit is a time unit in the first time unit pool.

In one subembodiment of the embodiment, any of the K1 time units is a slot.

In one subembodiment of the above embodiment, any of the K1 time units occupies more than one positive integer number of continuous symbols.

In one subsidiary embodiment of the subembodiment, the first time unit is a Y-th time unit among the K1 time units.

In one subsidiary embodiment of the subembodiment, the first time unit is a (Y−1)-th time unit among the K1 time units.

In one subsidiary embodiment of the subembodiment, the first time unit is a first one of time units among the K1 time units.

In one embodiment, Y is a positive integer.

In one embodiment, Y is a non-negative integer.

In one embodiment, the first signal is obtained after the first bit block is through at least CRC attachment, Code Block Segmentation, Per-CB CRC Attachment, channel encoding, Rate Matching and CB Concatenation.

In one embodiment, the first signal is obtained after the first bit block is through at least CRC attachment, channel encoding and rate matching.

In one embodiment, the first signal is obtained after the first bit block is through at least Scrambling, the Modulation and resource mapping.

In one embodiment, the first signal is obtained after the first bit block is through scrambling, the modulation operation, layer mapping, antenna port mapping and resource block mapping.

In one embodiment, the first signal is obtained after the first bit block is through CRC attachment, Code Block Segmentation, Per-CB CRC Attachment, channel encoding, rate matching and Code Block Concatenation.

In one embodiment, the first signal is obtained after the first bit block is through CRC attachment, channel encoding and rate matching.

In one embodiment, the first signal is obtained after the first bit block is through scrambling, the modulation operation and resource block mapping.

In one embodiment, the first signal is obtained after the first bit block is through scrambling, the modulation operation, layer mapping, antenna port mapping and resource block mapping.

In one embodiment, the first signal is obtained after the first bit block is sequentially through CRC attachment, Code Block Segmentation, Per-CB CRC Attachment, channel encoding, rate matching and Code Block Concatenation.

In one embodiment, the first signal is obtained after the first bit block is through channel coding, then is sequentially through scrambling, modulation operation, layer mapping, antenna port mapping and resource block mapping.

In one embodiment, the resource block mapping comprises mapping to an assigned RE in a physical resource block.

In one embodiment, the resource block mapping comprises mapping to an RE other than an assigned RE in a physical resource block.

In one embodiment, the resource block mapping comprises mapping to Virtual Resource Block and mapping from Virtual Resource Block to a physical resource block.

In one embodiment, the channel coding is based on a Low-density Parity-Check (LDPC) code.

In one embodiment, the channel coding is based on Turbo code.

In one embodiment, the channel coding is based on polar code.

In one embodiment, the first signaling is used to indicate a nrofHARQ-Processes field in TS 38.331.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports SPS services.

In one embodiment, the UE 201 can support multiple SPS configurations being activated at the same time.

In one embodiment, the UE 201 supports XR services.

In one embodiment, the XR in the present application comprises AR.

In one embodiment, the XR in the present application comprises VR.

In one embodiment, the gNB 203 corresponds to the first node in the present application.

In one embodiment, the gNB 203 supports SPS services.

In one embodiment, the gNB 203 can support multiple SPS configurations being activated at the same time.

In one embodiment, the gNB 203 supports XR services.

### Embodiment 3

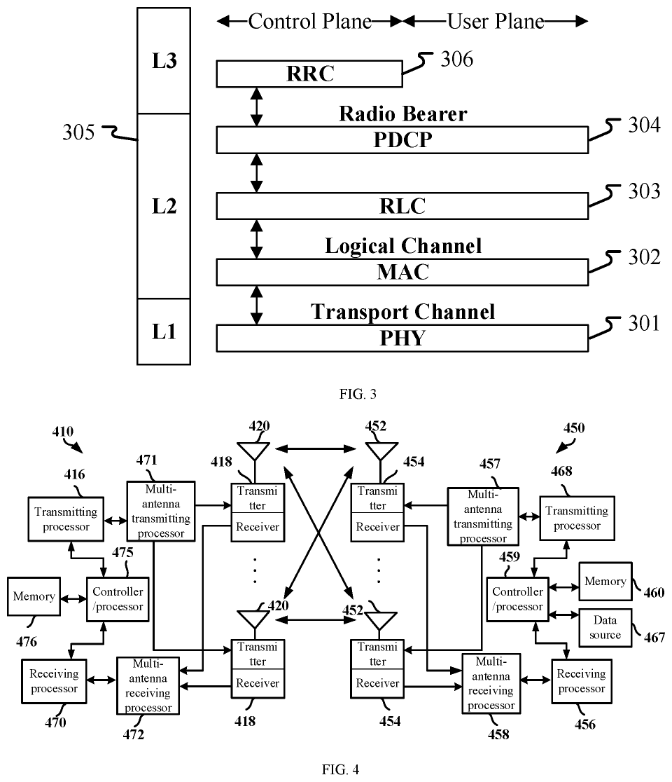

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first signaling is generated by the MAC 302 or the MAC 352.

In one embodiment, the first signaling is generated by the RRC 306.

In one embodiment, the second signaling is generated by the PHY 301 or the PHY 351.

In one embodiment, the second signaling is generated by the MAC 302 or the MAC 352.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the first node is a terminal.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

In one embodiment, the second node is a node used for managing multiple carriers.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first signaling and a second signaling, the first signaling is used to indicate an SPS configuration, the second signaling is used to provide a downlink assignment for the SPS configuration; then receives a first signal in a first time unit; the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the first communication device 450 comprises at least one processor and at least one memory. a memory that stores a computer readable instruction program. The computer readable instruction program generates an action when executed by at least one processor. The action includes: firstly receiving a first signaling and a second signaling, the first signaling being used to indicate an SPS configuration, the second signaling being used to provide a downlink assignment for the SPS configuration; then receiving a first signal in a first time unit; the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: firstly transmits a first signaling and a second signaling, the first signaling is used to indicate an SPS configuration, the second signaling is used to provide a downlink assignment for the SPS configuration; then transmits a first signal in a first time unit; the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the second communication device 410 comprises a memory that stores a computer readable instruction program. The computer readable instruction program generates an action when executed by at least one processor. The action includes: firstly transmitting a first signaling and a second signaling, the first signaling being used to indicate an SPS configuration, the second signaling being used to provide a downlink assignment for the SPS configuration; then transmitting a first signal in a first time unit; the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first signaling and a second signaling, the first signaling is used to indicate an SPS configuration, and the second signaling is used to provide a downlink assignment of the SPS configuration; at least first four of the antenna 420, the transmitter 418, the multi-antenna transmitting processor 471, the transmitting processor 416 and the controller/processor 475 are used to transmit a first signaling and a second signaling, the first signaling is used to indicate an SPS configuration, and the second signaling is used to provide a downlink assignment of the SPS configuration.

In one embodiment, at least first four of the antenna 452, the receiver 454, the multi-antenna receiving processor 458, the receiving processor 456 and the controller/processor 459 are used to receive a first signal in a first time unit; at least first four of the antenna 420, the transmitter 418, the multi-antenna transmitting processor 471, the transmitting processor 416 and the controller/processor 475 are used to transmit a first signal in a first time unit.

### Embodiment 5A

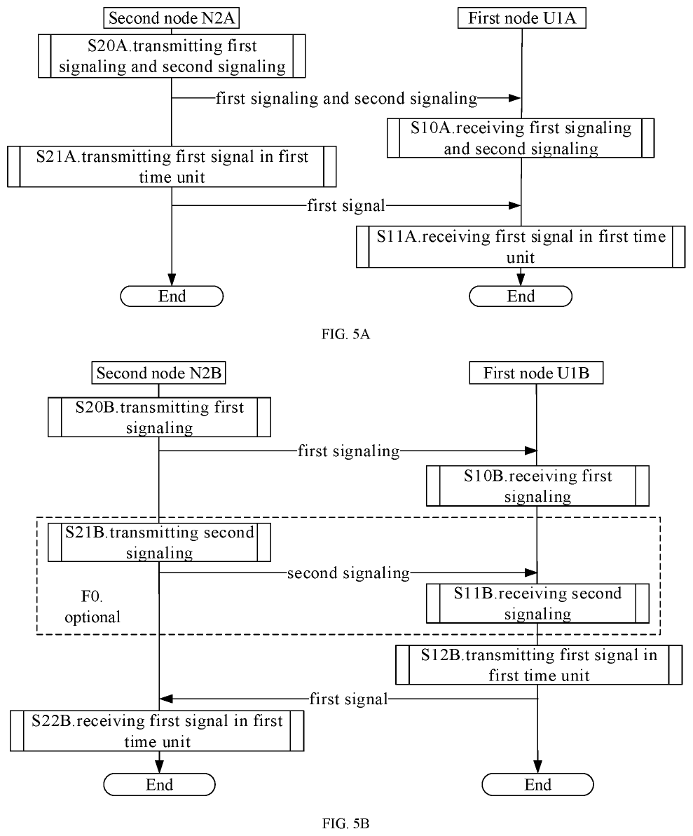

Embodiment 5A illustrates a flowchart of a first signaling, as shown in FIG. 5A. In FIG. 5A, a first node U1A and a second node N2A are in communications via a radio link. It is particularly underlined that the order illustrated in the embodiment does not put constraints over sequences of signal transmissions and implementations.

The first node U1A receives a first signaling and a second signaling in step S10A; receives a first signal in a first time unit in step S11A.

The second node N2A transmits a first signaling and a second signaling in step S20A; transmits a first signal in a first time unit in step S21A.

In embodiment 5A, the first signaling is used to indicate an SPS configuration, and the second signaling is used to provide a downlink assignment for the SPS configuration; the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, time-domain resources occupied by the first signaling and time-domain resources occupied by the second signaling belong to a same slot.

In one embodiment, time-domain resources occupied by the first signaling and time-domain resources occupied by the second signaling respectively belong to two different slots.

In one embodiment, time-domain resources occupied by the second signaling and time-domain resources occupied by the first signal belong to a same slot.

In one embodiment, time-domain resources occupied by the second signaling and time-domain resources occupied by the first signal respectively belong to two different slots.

In one embodiment, the second signaling is used to indicate an SPS activation; the second signaling is used to determine frequency-domain resources occupied by the first signal.

In one subembodiment of the embodiment, a Frequency Domain Assignment field comprised in the second signaling is used to indicate frequency-domain resources occupied by the first signal.

In one subembodiment of the embodiment, a Frequency Domain Assignment field comprised in the second signaling is used to indicate a frequency-domain location of a Resource Block (RB) occupied by the first signal.

In one subembodiment of the embodiment, a Frequency Domain Assignment field comprised in the second signaling is used to determine frequency-domain resources occupied by the first signal.

In one subembodiment of the embodiment, a Frequency Domain Assignment field comprised in the second signaling is used to determine a frequency-domain location of an RB occupied by the first signal.

In one subembodiment of the embodiment, a Frequency Domain Assignment field comprised in the second signaling is used to indicate a first RB set, the first RB set comprises a positive integer number of RBs greater than one, frequency-domain resources occupied by the first signal comprises at least the first RB set in the first RB set or a second RB set, the second RB set comprises a positive integer number of RBs greater than one, and a frequency-domain location of the first RB set is used to determine a frequency-domain location of the second RB set.

In one subsidiary embodiment of the subembodiment, whether frequency-domain resources occupied by the first signal comprise the second RB set is related to a value of Y.

In one example of the subsidiary embodiment; Y is equal to an odd number, and frequency-domain resources occupied by the first signal comprise the second RB set; Y is equal to an even number, and frequency-domain resources occupied by the first signal do not comprise the second RB set.

In one example of the subsidiary embodiment; Y is equal to an even number, and frequency-domain resources occupied by the first signal comprise the second RB set; Y is equal to an odd number, and frequency-domain resources occupied by the first signal do not comprise the second RB set.

In one example of the subsidiary embodiment; Y is less than a first threshold, and frequency-domain resources occupied by the first signal comprise the second RB set; Y is not less than a first threshold, and frequency-domain resources occupied by the first signal do not comprise the second RB set; the first threshold is fixed or the first threshold is configured through an RRC or MAC signaling; the first threshold is a positive integer greater than 1.

In one example of the subsidiary embodiment; Y is greater than a second threshold, and frequency-domain resources occupied by the first signal comprise the second RB set; Y is not greater less than a second threshold, and frequency-domain resources occupied by the first signal do not comprise the second RB set; the second threshold is fixed or the second threshold is configured through an RRC or MAC signaling; the second threshold is a positive integer greater than 1.

In one subsidiary embodiment of the subembodiment, a number of RB(s) comprised in the second RB set is fixed, or a number of RB(s) comprised in the second RB set is configured through a higher-layer signaling.

In one subsidiary embodiment of the subembodiment, a number of RB(s) comprised in the second RB set is unrelated to the second signaling.

In one subsidiary embodiment of the subembodiment, a number of RB(s) comprised in the second RB set is related to a service type of the first node.

In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one subembodiment of the embodiment, a number of bit(s) comprised in the first bit block is a TBS.

In one subembodiment of the embodiment, a number of RE(s) occupied by the first signal is related to a number of RB(s) occupied by the first signal, and a number of the RB(s) occupied by the first signal is related to Y.

In one subembodiment of the embodiment, when Y is equal to an odd number, a number of REs occupied by the first signal is equal to X1; when Y is equal to an even number, a number of REs occupied by the first signal is equal to X2; both X1 and X2 are positive integers greater than 1, and X1 is not equal to X2.

In one subembodiment of the embodiment, when Y is not greater than a third threshold, a number of REs occupied by the first signal is equal to X1; when Y is greater than a third threshold, a number of REs occupied by the first signal is equal to X2; both X1 and X2 are positive integers greater than 1, and X1 is not equal to X2; the third threshold is fixed or the third threshold is configured through an RRC or MAC signaling; the third threshold is a positive integer greater than 1.

In one subembodiment of the embodiment, when Y is greater than a fourth threshold, a number of REs occupied by the first signal is equal to X1; when Y is not greater than a fourth threshold, a number of REs occupied by the first signal is equal to X2; both X1 and X2 are positive integers greater than 1, and X1 is not equal to X2; the fourth threshold is fixed or the fourth threshold is configured through an RRC or MAC signaling; the fourth threshold is a positive integer greater than 1.

In one subsidiary embodiment of the above three subembodiments, the second signaling is used to determine a value of X1, and a value of X2 is related to a value of the X1.

In one subsidiary embodiment of the above three subembodiments, the second signaling is used to determine a value of X2, and a value of X1 is related to a value of the X2.

In one subsidiary embodiment of the above three subembodiments, a difference value of X1 and X2 is equal to X3; a value of X3 is configured through an RRC signaling or a MAC signaling, or a value of X3 is fixed.

In one subembodiment of the embodiment, the second signaling is used to indicate at least one of coding rate adopted by the channel coding to which the first bit block is subjected or a modulation order adopted by the modulation to which the first bit block is subjected.

In one subembodiment of the embodiment, the second signaling is used to indicate coding rate adopted by the channel coding to which the first bit block is subjected and a modulation order adopted by the modulation to which the first bit block is subjected.

In one embodiment, at least one of coding rate adopted by the channel coding to which the first bit block is subjected or a modulation order adopted by the modulation to which the first bit block is subjected is related to the Y.

In one subembodiment of the embodiment, frequency-domain resources occupied by the first signal is unrelated to Y.

In one subembodiment of the embodiment, a number of RB(s) occupied by the first signal is unrelated to an RB location and Y.

In one subembodiment of the embodiment, the second signaling is used to indicate frequency-domain resources occupied by the first signal.

In one subembodiment of the embodiment, a number of RE(s) occupied by the first signal is unrelated to Y.

In one subembodiment of the embodiment, when Y is equal to an odd number, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is equal to an even number, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index.

In one subembodiment of the embodiment, when Y is not greater than a fifth threshold, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is greater than a fifth threshold, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index; the fifth threshold is fixed or the fifth threshold is configured through an RRC or MAC signaling; the fifth threshold is a positive integer greater than 1.

In one subembodiment of the embodiment, when Y is greater than a sixth threshold, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is not greater than a sixth threshold, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index; the sixth threshold is fixed or the sixth threshold is configured through an RRC or MAC signaling; the sixth threshold is a positive integer greater than 1.

In one subsidiary embodiment of the above three subembodiments, the second signaling indicates a former of the first MCS index and the second MCS index.

In one subsidiary embodiment of the above three subembodiments, the second signaling indicates a latter of the first MCS index and the second MCS index.

In one subsidiary embodiment of the above three subembodiments, the second signaling indicates the first MCS index and the second MCS index not at the same time.

In one subembodiment of the above three embodiments, a difference value of the first MCS index and the second MCS index is equal to X4; a value of X4 is configured through an RRC signaling or a MAC signaling, or a value of X4 is fixed.

In one embodiment, the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

In one subembodiment of the embodiment, when the second signaling indicates the first MCS index, the target MCS index is the first MCS index.

In one subembodiment of the embodiment, when the second signaling indicates the second MCS index, the target MCS index is the second MCS index.

In one embodiment, the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

In one subembodiment of the embodiment, the first time unit corresponding to a value of the Y belongs to the first time unit set, and frequency-domain resources occupied by the first signal comprise the first RB set and the second RB set; the first time unit corresponding to a value of the Y belongs to the second time unit set, and frequency-domain resources occupied by the first signal comprise the first RB set and do not comprise the second RB set.

In one subembodiment of the embodiment, the first time unit corresponding to a value of the Y belongs to the first time unit set, and a number of REs occupied by the first signal is equal to X1; the first time unit corresponding to a value of the Y belongs to the second time unit set, and a number of REs occupied by the first signal is equal to X2; both X1 and X2 are positive integers greater than 1, and X1 is not equal to X2.

In one subembodiment of the embodiment, the first time unit corresponding to a value of Y belongs to the first time unit set, the coding rate adopted by the channel coding to which the first bit block is subjected and the modulation order adopted by the modulation to which the first bit block is subjected adopt a coding rate corresponding to a first MCS index and a modulation order corresponding to a first MCS index; the first time unit corresponding to a value of Y belongs to the second time unit set, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is different from the second MCS index, and the second signaling indicates the first MCS index or the second MCS index.

In one embodiment, the first signaling is used to determine at least one of the first time unit set or the second time unit set.

In one subembodiment of the embodiment, the first signaling is used to indicate the first time unit set.

In one subembodiment of the embodiment, the first signaling is used to indicate the second time unit set.

In one subembodiment of the embodiment, the first signaling is used to indicate the first time unit set and the second time unit set.

In one subembodiment of the embodiment, the first signaling is used to indicate the first time unit set from the first time unit pool.

In one subembodiment of the embodiment, the first signaling is used to indicate the second time unit set from the first time unit pool.

In one subembodiment of the embodiment, the first signaling is used to indicate the first time unit set and the second time unit set from the first time unit pool.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, the first signal is for a first service type, and a period of the first service type is equal to M1 milliseconds, M1 being a real number greater than 1, and a number of RB(s) occupied by the first signal is equal to a first integer or a second integer; the first integer is not equal to the second integer; the first integer and the second integer are both positive integers; a value of M1 is used to determine a ratio of the first integer to the second integer.

In one embodiment, the first signal is for a first service type, and a period of the first service type is equal to M1 milliseconds, M1 being a real number greater than 1, and a number of RE(s) occupied by the first signal is equal to a third integer or a fourth integer; the third integer is not equal to the fourth integer; the third integer and the fourth integer are both positive integers greater than 1; a value of M1 is used to determine a ratio of the third integer to the fourth integer.

In one embodiment, the first signal is for a first service type, a period of the first service type is equal to M1 milliseconds, M1 being a real number greater than 1, and a value of the M1 is used to determine a ratio of a number of time unit(s) comprised in the first time unit set to a number of time unit(s) comprised in the second time unit set.

### Embodiment 5B

Embodiment 5B illustrates a flowchart of a first signaling, as shown in FIG. 5B. In FIG. 5B, a first node U1B and a second node N2B are in communications via a radio link. It is particularly underlined that the order illustrated in the embodiment does not put constraints over sequences of signal transmissions and implementations. Steps in the box labeled FO in the figure are optional.

The first node U1B receives a first signaling in step S10B; receives a second signaling in step S11B; transmits a first signal in a first time unit in step S12B.

The second node N2B transmits a first signaling in step S20B; transmits a second signaling in step S21B; receives a first signal in a first time unit in step S22B.

In embodiment 5B, the first signaling is used to indicate a configuration of configured grant; the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer; when the second signaling is transmitted, a CRC comprised in the second signaling is scrambled through a first RNTI, the second signaling is used to indicate that the configured grant indicated by the first signaling is activated, the second signaling is a physical-layer signaling, and the first RNTI is an RNTI other than a C-RNTI.

In one embodiment, the meaning of the above phrase that the configured grant indicated by the first signaling is configured comprises: the configured grant is configured by an RRC signaling bearing the first signaling, and the configured grant is Type 1 configured grant.

In one embodiment, the meaning of the above phrase that the configured grant indicated by the first signaling is configured comprises: the configured grant is configured by an RRC signaling bearing the first signaling, the configured grant is activated by a dynamic signaling, and the configured grant is Type 2 configured grant.

In one embodiment, the second signaling is transmitted earlier than the first signal.

In one embodiment, the first signaling is used for determining frequency-domain resources occupied by the first signal.

In one subembodiment of the embodiment, a FrequencyDomainAllocation field comprised in the first signaling is used to indicate frequency-domain resources occupied by the first signal.

In one subembodiment of the embodiment, a FrequencyDomainAllocation field comprised in the first signaling is used to indicate a frequency-domain location of a Resource Block (RB) occupied by the first signal.

In one subembodiment of the embodiment, a FrequencyDomainAllocation field comprised in the first signaling is used to indicate a third RB set, the third RB set comprises more than one positive integer number of RBs, frequency-domain resources occupied by the first signal comprise at least the third RB set in the third RB set or a fourth RB set, the fourth RB set comprises more than one positive integer number of RBs, and a frequency-domain location of the third RB set is used to determine a frequency-domain location of the fourth RB set.

In one subsidiary embodiment of the subembodiment, whether frequency-domain resources occupied by the first signal comprise the fourth RB set is related to a value of Y.

In one example of the subsidiary embodiment; Y is equal to an odd number, and frequency-domain resources occupied by the first signal comprise the fourth RB set; Y is equal to an even number, and frequency-domain resources occupied by the first signal do not comprise the fourth RB set.

In one example of the subsidiary embodiment; Y is equal to an even number, and frequency-domain resources occupied by the first signal comprise the fourth RB set; Y is equal to an odd number, and frequency-domain resources occupied by the first signal do not comprise the fourth RB set.

In one example of the subsidiary embodiment; Y is less than a first threshold, and frequency-domain resources occupied by the first signal comprise the fourth RB set; Y is not less than a first threshold, and frequency-domain resources occupied by the first signal do not comprise the fourth RB set; the first threshold is fixed or the first threshold is configured through an RRC or MAC signaling; the first threshold is a positive integer greater than 1.

In one example of the subsidiary embodiment; Y is greater than a second threshold, and frequency-domain resources occupied by the first signal comprise the fourth RB set; Y is not greater less than a second threshold, and frequency-domain resources occupied by the first signal do not comprise the fourth RB set; the second threshold is fixed or the second threshold is configured through an RRC or MAC signaling; the second threshold is a positive integer greater than 1.

In one subsidiary embodiment of the subembodiment, a number of RB(s) comprised in the fourth RB set is fixed, or a number of RB(s) comprised in the fourth RB set is configured through a higher-layer signaling.

In one subsidiary embodiment of the subembodiment, a number of RB(s) comprised in the fourth RB set is unrelated to the first signaling.

In one subsidiary embodiment of the subembodiment, a number of RB(s) comprised in the fourth RB set is related to a service type of the first node U1.

In one embodiment, a physical-layer channel occupied by the second signaling comprises a Physical Downlink Control Channel (PDCCH).

In one embodiment, the second signaling is Downlink Control Information (DCI).

In one embodiment, the second signaling is an uplink grant.

In one embodiment, a DCI format adopted by the second signaling is DCI format 0_1 or DCI format 0_2.

In one embodiment, the second signaling is used to trigger a transmission of the configured grant indicated by the first signaling in a first one of uplink grants in time domain.

In one embodiment, the second signaling is used to trigger a transmission of a PUSCH corresponding to the configured grant indicated by the first signaling in a first one of uplink grants in time domain.

In one embodiment, when the second signaling is used to indicate that the configured grant indicated by the first signaling is activated, the configured grant indicated by the first signaling is a Type 2 configured grant.

In one embodiment, when the second signaling is used to indicate that the configured grant indicated by the first signaling is activated, the second signaling is used to indicate configuration information of the first signal, and the configuration information comprises at least one of the following:
occupied frequency-domain resources;
occupied time-domain resources;
an adopted MCS;
an occupied HARQ process number.

In one embodiment, the first RNTI is a Configured Scheduling Radio Network Temporary Identifier (CS-RNTI).

In one embodiment, the first RNTI is configured through an RRC signaling.

In one embodiment, the first signaling is used to determine a first time unit pool, the first time unit pool comprises K1 time units, K1 being a positive integer greater than 1, and the first time unit is a time unit in the first time unit pool.

In one subembodiment of the embodiment, any of the K1 time units is a slot.

In one subembodiment of the above embodiment, any of the K1 time units occupies more than one positive integer number of continuous symbols.

In one subembodiment of the above embodiment, the second signaling is used to determine a first time unit set, the first time unit set comprises K2 time units, any of the K2 time units belongs to the first time unit pool, and the first time unit is one of the K2 time units.

In one subsidiary embodiment of the subembodiment, the second signaling is used to determine an earliest time unit located in time domain among the K2 time units.

In one subsidiary embodiment of the subembodiment, the first time unit is a Y-th time unit among the K2 time units.

In one subsidiary embodiment of the subembodiment, the first time unit is a (Y−1)-th time unit among the K2 time units.

In one subsidiary embodiment of the subembodiment, a time unit where the second signaling is located is a first one of time units among the K2 time units.

In one embodiment, the second signaling is used to determine frequency-domain resources occupied by the first signal.

In one subembodiment of the embodiment, a Frequency Domain Assignment field comprised in the second signaling is used to indicate frequency-domain resources occupied by the first signal.

In one subembodiment of the embodiment, a Frequency Domain Resource Assignment field comprised in the second signaling is used to indicate a frequency-domain location of a Resource Block (RB) occupied by the first signal.

In one subembodiment of the embodiment, a Frequency Domain Resource Assignment field comprised in the second signaling is used to indicate a first RB set, the first RB set comprises a positive integer number of RBs greater than one, frequency-domain resources occupied by the first signal comprises at least the first RB set in the first RB set or a second RB set, the second RB set comprises a positive integer number of RBs greater than one, and a frequency-domain location of the first RB set is used to determine a frequency-domain location of the second RB set.

In one subsidiary embodiment of the subembodiment, whether frequency-domain resources occupied by the first signal comprise the second RB set is related to a value of Y.

In one example of the subsidiary embodiment; Y is equal to an odd number, and frequency-domain resources occupied by the first signal comprise the second RB set; Y is equal to an even number, and frequency-domain resources occupied by the first signal do not comprise the second RB set.

In one example of the subsidiary embodiment; Y is equal to an even number, and frequency-domain resources occupied by the first signal comprise the second RB set; Y is equal to an odd number, and frequency-domain resources occupied by the first signal do not comprise the second RB set.

In one example of the subsidiary embodiment; Y is less than a first threshold, and frequency-domain resources occupied by the first signal comprise the second RB set; Y is not less than a first threshold, and frequency-domain resources occupied by the first signal do not comprise the second RB set; the first threshold is fixed or the first threshold is configured through an RRC or MAC signaling; the first threshold is a positive integer greater than 1.

In one example of the subsidiary embodiment; Y is greater than a second threshold, and frequency-domain resources occupied by the first signal comprise the second RB set; Y is not greater less than a second threshold, and frequency-domain resources occupied by the first signal do not comprise the second RB set; the second threshold is fixed or the second threshold is configured through an RRC or MAC signaling; the second threshold is a positive integer greater than 1.

In one subsidiary embodiment of the subembodiment, a number of RB(s) comprised in the second RB set is fixed, or a number of RB(s) comprised in the second RB set is configured through a higher-layer signaling.

In one subsidiary embodiment of the subembodiment, a number of RB(s) comprised in the second RB set is unrelated to the second signaling.

In one subsidiary embodiment of the subembodiment, a number of RB(s) comprised in the second RB set is related to a service type of the first node U1.

In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, a number of bit(s) comprised in the first bit block is TBS.

In one embodiment, a number of RE(s) occupied by the first signal is related to a number of RB(s) occupied by the first signal, and a number of the RB(s) occupied by the first signal is related to Y.

In one embodiment, when Y is equal to an odd number, a number of REs occupied by the first signal is equal to X1; when Y is equal to an even number, a number of REs occupied by the first signal is equal to X2; both X1 and X2 are positive integers greater than 1, and X1 is not equal to X2.

In one embodiment, when Y is not greater than a third threshold, a number of REs occupied by the first signal is equal to X1; when Y is greater than a third threshold, a number of REs occupied by the first signal is equal to X2; both X1 and X2 are positive integers greater than 1, and X1 is not equal to X2; the third threshold is fixed or the third threshold is configured through an RRC or MAC signaling; the third threshold is a positive integer greater than 1.

In one embodiment, when Y is greater than a fourth threshold, a number of REs occupied by the first signal is equal to X1; when Y is not greater than a fourth threshold, a number of REs occupied by the first signal is equal to X2; both X1 and X2 are positive integers greater than 1, and X1 is not equal to X2; the fourth threshold is fixed or the fourth threshold is configured through an RRC or MAC signaling; the fourth threshold is a positive integer greater than 1.

In one subembodiment of the above three embodiments, when the configured grant indicated by the first signaling is Type 2 configured grant, the second signaling is used to determine a value of X1, and a value of X2 is related to a value of X1.

In one subembodiment of the above three embodiments, when the configured grant indicated by the first signaling is Type 2 configured grant, the second signaling is used to determine a value of X2, and a value of X1 is related to a value of X2.

In one subembodiment of the above three embodiments, when the configured grant indicated by the first signaling is Type 1 configured grant, the first signaling is used to determine a value of X1, and a value of X2 is related to a value of X1.

In one subembodiment of the above three embodiments, when the configured grant indicated by the first signaling is Type 1 configured grant, the first signaling is used to determine a value of X2, and a value of X1 is related to a value of X2.

In one subembodiment of the above three embodiments, a difference value of X1 and X2 is equal to X3; a value of X3 is configured through an RRC signaling or a MAC signaling, or a value of X3 is fixed.

In one embodiment, when the configured grant indicated by the first signaling is Type 2 configured grant, the second signaling is used to indicate at least one of coding rate adopted by the channel coding to which the first bit block is subjected or a modulation order adopted by the modulation to which the first bit block is subjected.

In one embodiment, when the configured grant indicated by the first signaling is Type 2 configured grant, the second signaling is used to indicate coding rate adopted by the channel coding to which the first bit block is subjected and a modulation order adopted by the modulation to which the first bit block is subjected.

In one embodiment, when the configured grant indicated by the first signaling is Type 1 configured grant, the first signaling is used to indicate at least one of coding rate adopted by the channel coding to which the first bit block is subjected or a modulation order adopted by the modulation to which the first bit block is subjected.

In one embodiment, when the configured grant indicated by the first signaling is Type 1 configured grant, the first signaling is used to indicate coding rate adopted by the channel coding to which the first bit block is subjected and a modulation order adopted by the modulation to which the first bit block is subjected.

In one embodiment, at least one of coding rate adopted by the channel coding to which the first bit block is subjected or a modulation order adopted by the modulation to which the first bit block is subjected is related to the Y.

In one embodiment, frequency-domain resources occupied by the first signal is unrelated to Y.

In one embodiment, a number of RB(s) occupied by the first signal is unrelated to a location of the RB and Y.

In one embodiment, when the configured grant indicated by the first signaling is Type 1 configured grant, the first signaling is used to indicate frequency-domain resources occupied by the first signal.

In one embodiment, when the configured grant indicated by the first signaling is Type 2 configured grant, the second signaling is used to indicate frequency-domain resources occupied by the first signal.

In one embodiment, a number of RE(s) occupied by the first signal is unrelated to Y.

In one embodiment, when Y is equal to an odd number, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is equal to an even number, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index.

In one embodiment, when Y is not greater than a fifth threshold, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is greater than a fifth threshold, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index; the fifth threshold is fixed or the fifth threshold is configured through an RRC or MAC signaling; the fifth threshold is a positive integer greater than 1.

In one embodiment, when Y is greater than a sixth threshold, the coding rate adopted by the channel coding to which the first bit block is subjected and the modulation order adopted by the modulation to which the first bit block is subjected adopt a coding rate corresponding to a first MCS index and a modulation order corresponding to a first MCS index; when Y is not greater than a sixth threshold, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is related to the second MCS index, and the second signaling is used to indicate the first MCS index or the second MCS index; the sixth threshold is fixed or the sixth threshold is configured through an RRC or MAC signaling; the sixth threshold is a positive integer greater than 1.

In one subembodiment of the above three embodiments, when the configured grant indicated by the first signaling is Type 2 configured grant, the second signaling indicates a former of the first MCS index and the second MCS index.

In one subembodiment of the above three embodiments, when the configured grant indicated by the first signaling is Type 2 configured grant, the second signaling indicates a latter of the first MCS index and the second MCS index.

In one subembodiment of the above three embodiments, when the configured grant indicated by the first signaling is Type 2 configured grant, the second signaling indicates the first MCS index and the second MCS index not at the same time.

In one subembodiment of the above three embodiments, when the configured grant indicated by the first signaling is Type 1 configured grant, the first signaling indicates a former of the first MCS index and the second MCS index.

In one subembodiment of the above three embodiments, when the configured grant indicated by the first signaling is Type 1 configured grant, the first signaling indicates a latter of the first MCS index and the second MCS index.

In one subembodiment of the above three embodiments, when the configured grant indicated by the first signaling is Type 1 configured grant, the first signaling indicates the first MCS index and the second MCS index not at the same time.

In one subembodiment of the above three embodiments, a difference value of the first MCS index and the second MCS index is equal to X4; a value of X4 is configured through an RRC signaling or a MAC signaling, or a value of X4 is fixed.

In one embodiment, the first signaling is used to determine a first MCS table and the second signaling is used to indicate a target MCS index from the first MCS table, or the first signaling is used to indicate a target MCS index; the target MCS index and Y are used together to determine at least one of coding rate adopted by the channel coding to which the first bit block is subjected or a modulation order adopted by the modulation to which the first bit block is subjected.

In one subembodiment of the embodiment, when the configured grant indicated by the first signaling is Type 1 configured grant, the first signaling is used to indicate the target MCS index.

In one subsidiary embodiment of the subembodiment, when the first signaling indicates the first MCS index, the target MCS index is the first MCS index.

In one subsidiary embodiment of the subembodiment, when the first signaling indicates the second MCS index, the target MCS index is the second MCS index.

In one subembodiment of the embodiment, when the configured grant indicated by the first signaling is Type 2 configured grant, the first signaling is used to determine the first MCS table and the second signaling is used to indicate the target MCS index from the first MCS table.

In one subsidiary embodiment of the subembodiment, when the second signaling indicates the first MCS index, the target MCS index is the first MCS index.

In one sub-subsidiary embodiment of the subembodiment, when the second signaling indicates the second MCS index, the target MCS index is the second MCS index.

In one embodiment, the first signaling is used to indicate a first configured grant configuration index, and a period of a configured grant corresponding to the first configured grant configuration index is used to determine a first time unit set and a second time unit set; both the first time unit set and the second time unit set comprise positive integer number of time units greater than 1; the first time unit set comprises the first time unit or the second time unit set comprises the first time unit.

In one subembodiment of the embodiment, the configured grant corresponding to the first configured grant configuration index is the configured grant indicated by the first signaling.

In one subembodiment of the embodiment, the first configured grant configuration index is ConfiguredGrantConfigIndex in TS 38.331.

In one subembodiment of the embodiment; the first time unit corresponding to a value of the Y belongs to the first time unit set, and frequency-domain resources occupied by the first signal comprise the first RB set and the second RB set; the first time unit corresponding to a value of the Y belongs to the second time unit set, and frequency-domain resources occupied by the first signal comprise the first RB set and do not comprise the second RB set.

In one subembodiment of the above embodiment; the first time unit corresponding to a value of the Y belongs to the first time unit set, and a number of REs occupied by the first signal is equal to X1; the first time unit corresponding to a value of the Y belongs to the second time unit set, and a number of REs occupied by the first signal is equal to X2; both X1 and X2 are positive integers greater than 1, and X1 is not equal to X2.

In one subembodiment of the above embodiment; the first time unit corresponding to a value of Y belongs to the first time unit set, the coding rate adopted by the channel coding to which the first bit block is subjected and the modulation order adopted by the modulation to which the first bit block is subjected adopt a coding rate corresponding to a first MCS index and a modulation order corresponding to a first MCS index; the first time unit corresponding to a value of Y belongs to the second time unit set, the coding rate adopted by the channel coding to which the first bit block is subjected and the modulation order adopted by the modulation to which the first bit block is subjected adopt a coding rate corresponding to a second MCS index and a modulation order corresponding to a second MCS index; the first MCS index is different from the second MCS index, and the second signaling indicates the first MCS index or the second MCS index.

In one subembodiment of the embodiment, the second signaling is used to indicate an earliest time unit located in time domain among all time units comprised in the first time unit set and the second time unit set.

In one embodiment, the first signaling is used to determine at least one of the first time unit set or the second time unit set.

In one subembodiment of the embodiment, the first signaling is used to indicate the first time unit set.

In one subembodiment of the embodiment, the first signaling is used to indicate the second time unit set.

In one subembodiment of the embodiment, the first signaling is used to indicate the first time unit set and the second time unit set.

In one subembodiment of the embodiment, the first signaling is used to indicate the first time unit set from the first time unit pool.

In one subembodiment of the embodiment, the first signaling is used to indicate the second time unit set from the first time unit pool.

In one subembodiment of the embodiment, the first signaling is used to indicate the first time unit set and the second time unit set from the first time unit pool.

In one subembodiment of the embodiment, the second signaling is used to indicate the first time unit set.

In one subembodiment of the embodiment, the second signaling is used to indicate the second time unit set.

In one subembodiment of the embodiment, the second signaling is used to indicate the first time unit set and the second time unit set.

In one subembodiment of the embodiment, the second signaling is used to indicate the first time unit set from the first time unit pool.

In one subembodiment of the embodiment, the second signaling is used to indicate the second time unit set from the first time unit pool.

In one subembodiment of the embodiment, the second signaling is used to indicate the first time unit set and the second time unit set from the first time unit pool.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one subembodiment of the embodiment, a number of RB(s) occupied by the first signal is equal to a first integer or a second integer; the first integer is not equal to the second integer; the first integer and the second integer are both positive integers; a value of M1 is used to determine a ratio of the first integer to the second integer.

In one subembodiment of the embodiment, a number of RE(s) occupied by the first signal is equal to a third integer or a fourth integer; the third integer is not equal to the fourth integer; the third integer and the fourth integer are both positive integers greater than 1; a value of M1 is used to determine a ratio of the third integer to the fourth integer.

In one subembodiment of the embodiment, a value of the M1 is used to determine a ratio of a number of time unit(s) comprised in the first time unit set to a number of time unit(s) comprised in the second time unit set.

### Embodiment 6A

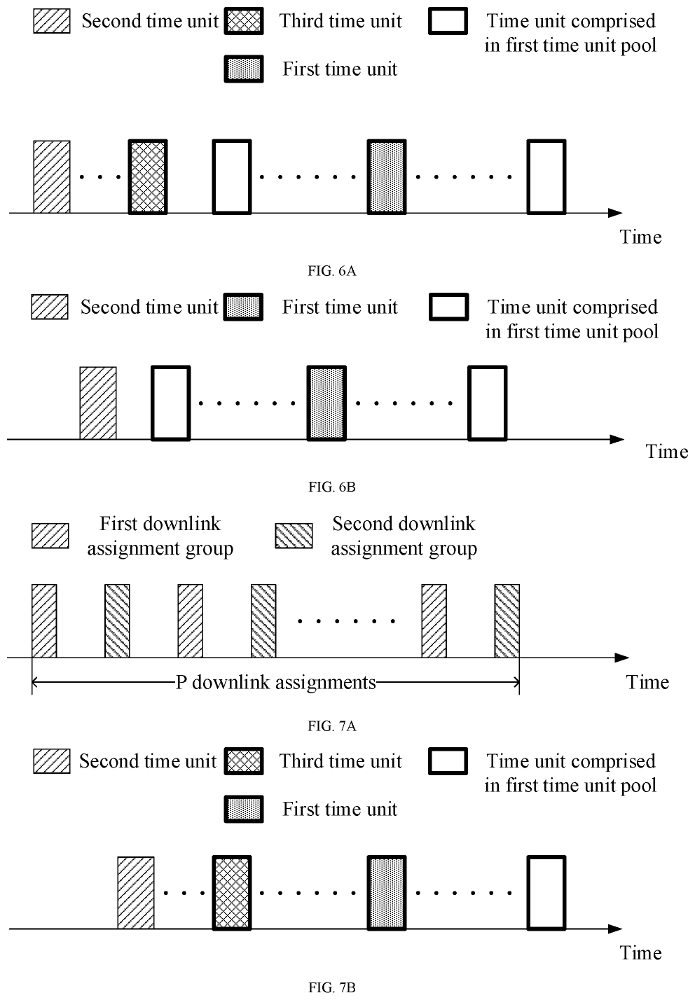

Embodiment 6A illustrates a schematic diagram of a first time unit, as shown in FIG. 6A. In FIG. 6A, the first signaling indicates an SPS configuration in a second time unit, and the second signaling activates the SPS configuration in a third time unit; the first node in the present application receives a transmission of a downlink assignment corresponding to the SPS configuration in a time unit in a first time unit pool illustrated in the figure; the first time unit is a Y-th time unit in the first time unit pool.

In one embodiment, the third time unit is a time unit in the first time unit pool.

In one embodiment, the first node receives a transmission of a downlink assignment corresponding to the SPS configuration in the third time unit.

In one embodiment, the first node receives a transmission of a first one of downlink assignments corresponding to the SPS configuration in the third time unit.

### Embodiment 6B

Embodiment 6B illustrates a schematic diagram of a first time unit, as shown in FIG. 6B. In FIG. 6B, the first signaling indicates configuration information of a configured grant in a second time unit, and a time unit in a first time unit pool illustrated in the figure is a time unit occupied by an uplink transmission that complies with a period of the configured grant indicated by the first signaling; the first time unit is a Y-th time unit in the first time unit pool.

In one embodiment, the configured grant indicated by the first signaling illustrated in FIG. 6B does not need to be activated through the second signaling in the present application.

### Embodiment 7A

Embodiment 7A illustrates a schematic diagram of a downlink assignment, as shown in FIG. 7A. In FIG. 7A, the second signaling is used to activate an SPS configuration, the first node receives P downlink assignments before the SPS configuration is released, the P downlink assignments respectively correspond to P PDSCHs, P being a positive integer greater than the Y, and the Y-th downlink assignment is a Y-th downlink assignment in the P downlink assignments. As shown in the figure, the P downlink assignments are divided into a first downlink assignment group and a second downlink assignment group, the first downlink assignment group consists of downlink assignment(s) with sequence number of (2*i−1) in the P downlink assignments, and the second downlink assignment group consists of downlink assignment(s) with sequence number of (2*i) in the P downlink assignments; i is a smallest positive integer greater than 0 and not less than 0.5*P.

In one embodiment, when a Y-th downlink assignment belongs to the first downlink assignment group, the first signal adopts a first MCS; when a Y-th downlink assignment belongs to the second downlink assignment group, the first signal adopts a second MCS; the first MCS is different from the second MCS.

In one embodiment, when a Y-th downlink assignment belongs to the first downlink assignment group, a number of REs occupied by the first signal is equal to X1; when a Y-th downlink assignment belongs to the second downlink assignment group, a number of REs occupied by the first signal is equal to X2; X1 is different from X2, and both X1 and X2 are positive integers greater than 1.

In one embodiment, when a Y-th downlink assignment belongs to the first downlink assignment group, a number of RB(s) occupied by the first signal is equal to a first integer; when a Y-th downlink assignment belongs to the second downlink assignment group, a number of RB(s) occupied by the first signal is equal to a second integer; the first integer is different from the second integer, and the first integer and the second integer are both positive integers.

### Embodiment 7B

Embodiment 7B illustrates another schematic diagram of a first time unit, as shown in FIG. 7B. In FIG. 7B, the first signaling indicates configuration information of a configured grant in a second time unit, and a third time unit shown in the figure is a time unit occupied by the first one of uplink grants belonging to the configured grant after the second signaling activates the configured grant indicated by the first signaling; the first signaling and the second signaling are used together to determine a first time unit pool, the third time unit is a first one of time units in the first time unit pool, and the first time unit is a Y-th time unit in the first time unit pool.

In one embodiment, the second signaling is used to determine a time-domain location of the third time unit, and the first signaling is used to determine a distance between any two adjacent time units in time domain in the first time unit pool.

In one subembodiment of the embodiment, a period of the configured grant indicated by the first signaling is used to determine a distance between any two adjacent time units in time domain in the first time unit pool.

In one embodiment, the configured grant indicated by the first signaling illustrated in FIG. 7B needs to be activated through the second signaling in the present application.

In one embodiment, the second signaling is transmitted in the third time unit.

In one embodiment, time-domain resources occupied by the second signaling are earlier than the third time unit.

In one embodiment, the second signaling is used to indicate the third time unit.

### Embodiment 8A

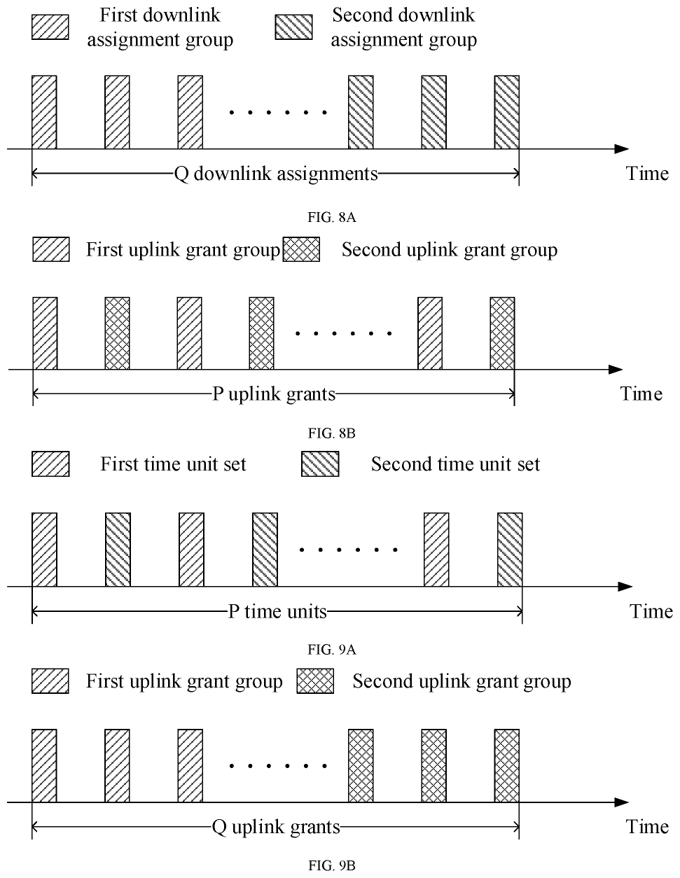

Embodiment 8A illustrates a schematic diagram of a downlink assignment, as shown in FIG. 8A. In FIG. 8A, the second signaling is used to activate an SPS configuration, the first node receives Q downlink assignments before the SPS configuration is released, the Q downlink assignments respectively correspond to Q PDSCHs, Q being a positive even number greater than Y, and the Y-th downlink assignment(s) is(are) Y-th downlink assignment(s) in the Q downlink assignments. As shown in the figure, the Q downlink assignments are divided into a first downlink assignment group and a second downlink assignment group, the first downlink assignment group consists of first 0.5*Q downlink assignment(s) among the Q downlink assignments, and the second downlink assignment group consists last 0.5*Q downlink assignment(s) among the Q downlink assignments.

In one embodiment, when a Y-th downlink assignment belongs to the first downlink assignment group, the first signal adopts a first MCS; when a Y-th downlink assignment belongs to the second downlink assignment group, the first signal adopts a second MCS; the first MCS is different from the second MCS.

In one embodiment, when a Y-th downlink assignment belongs to the first downlink assignment group, a number of REs occupied by the first signal is equal to X1; when a Y-th downlink assignment belongs to the second downlink assignment group, a number of REs occupied by the first signal is equal to X2; X1 is different from X2, and both X1 and X2 are positive integers greater than 1.

In one embodiment, when a Y-th downlink assignment belongs to the first downlink assignment group, a number of RB(s) occupied by the first signal is equal to a first integer; when a Y-th downlink assignment belongs to the second downlink assignment group, a number of RB(s) occupied by the first signal is equal to a second integer; the first integer is different from the second integer, and the first integer and the second integer are both positive integers.

### Embodiment 8B

Embodiment 8B illustrates a schematic diagram of an uplink grant, as shown in FIG. 8B. In FIG. 8B, the first signaling is used to configure a configured grant, the first node receives P uplink grants before the configured grant is released, the P uplink grants respectively correspond to P PUSCHs, P being a positive integer greater than Y, and the Y-th uplink grant is a Y-th uplink grant among the P uplink grant(s). As shown in the figure, the P uplink grants are respectively divided into a first uplink grant group and a second uplink grant group, the first uplink grant group consists of uplink grant(s) with sequence number of (2*i−1) among the P uplink grant(s), and the second uplink grant group consists of uplink grant(s) with sequence number of (2*i) among the P uplink grant(s); i is a smallest positive integer greater than 0 and not less than 0.5*P.

In one embodiment, when a Y-th downlink assignment belongs to the first uplink grant group, the first signal adopts a first MCS; when a Y-th downlink assignment belongs to the second uplink grant group, the first signal adopts a second MCS; the first MCS is different from the second MCS.

In one embodiment, when a Y-th uplink grant belongs to the first uplink grant group, a number of REs occupied by the first signal is equal to X1; when a Y-th uplink grant belongs to the second uplink grant group, a number of REs occupied by the first signal is equal to X2; X1 is different from X2, and both X1 and X2 are positive integers greater than 1.

In one embodiment, when a Y-th uplink grant belongs to the first uplink grant group, a number of RB(s) occupied by the first signal is equal to a first integer; when a Y-th uplink grant belongs to the second uplink grant group, a number of RB(s) occupied by the first signal is equal to a second integer; the first integer is different from the second integer, and the first integer and the second integer are both positive integers.

### Embodiment 9A

Embodiment 9A illustrates a schematic diagram of a first time unit set and a second time unit set, as shown in FIG. 9A. In FIG. 9A, the second signaling is used to activate an SPS configuration, the first node receives P downlink assignments before the SPS configuration is released, the P downlink assignments respectively correspond to P PDSCHs, the P PDSCHs are respectively transmitted in P time units, P being a positive integer greater than Y, and the Y-th downlink assignment is a Y-th time unit among the P time units. As shown in the figure, the P time units are divided into a first time unit set and a second time unit set, the first time unit set consists of time unit(s) with sequence number of (2*i−1) among the P time units, and the second time unit set consists of time unit(s) with sequence number of (2*i) among the P time units; i is a smallest positive integer greater than 0 and not less than 0.5*P.

In one embodiment, when a Y-th time unit belongs to the first time unit set, the first signal adopts a first MCS; when a Y-th time unit belongs to the second time unit set, the first signal adopts a second MCS; the first MCS is different from the second MCS.

In one embodiment, when a Y-th time unit belongs to the first time unit set, a number of REs occupied by the first signal is equal to X1; when a Y-th time unit belongs to the second time unit set, a number of REs occupied by the first signal is equal to X2; X1 is different from X2, and both X1 and X2 are positive integers greater than 1.

In one embodiment, when a Y-th time unit belongs to the first time unit set, a number of RB(s) occupied by the first signal is equal to a first integer; when a Y-th time unit belongs to the second time unit set, a number of RB(s) occupied by the first signal is equal to a second integer; the first integer is different from the second integer, and the first integer and the second integer are both positive integers.

### Embodiment 9B

Embodiment 9B illustrates a schematic diagram of an uplink grant, as shown in FIG. 9B. In FIG. 9B, the first signaling is used to configure a configured grant, the first node receives Q uplink grants before the configured grant is released, the Q upink grants respectively correspond to Q PUSCHs, Q being a positive integer greater than Y, and the Y-th uplink grant is a Y-th uplink grant among the Q uplink grants. As shown in the figure, the Q uplink grants are divided into a first uplink grant group and a second uplink grant group, the first uplink grant group consists of first 0.5*Q uplink grant(s) among the Q uplink grants, and the second uplink grant group consists of last 0.5*Q uplink grant(s) among the Q uplink grants.

In one embodiment, when a Y-th uplink grant belongs to the first uplink grant group, the first signal adopts a first MCS; when a Y-th uplink grant belongs to the second uplink grant group, the first signal adopts a second MCS; the first MCS is different from the second MCS.

In one embodiment, when a Y-th uplink grant belongs to the first uplink grant group, a number of REs occupied by the first signal is equal to X1; when a Y-th uplink grant belongs to the second uplink grant group, a number of REs occupied by the first signal is equal to X2; X1 is different from X2, and both X1 and X2 are positive integers greater than 1.

In one embodiment, when a Y-th uplink grant belongs to the first uplink grant group, a number of RB(s) occupied by the first signal is equal to a first integer; when a Y-th uplink grant belongs to the second uplink grant group, a number of RB(s) occupied by the first signal is equal to a second integer; the first integer is different from the second integer, and the first integer and the second integer are both positive integers.

### Embodiment 10A

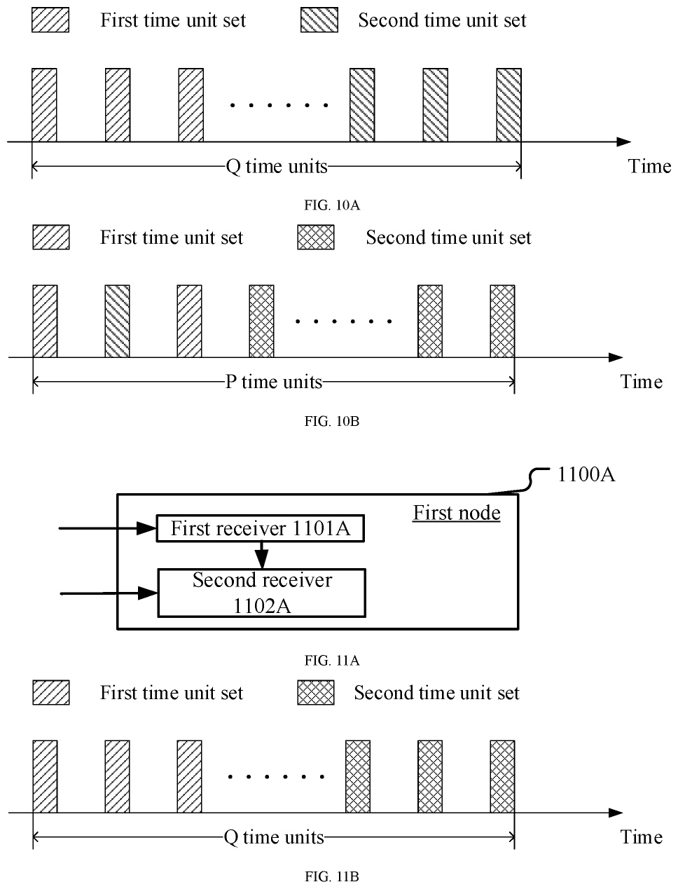

Embodiment 10A illustrates a schematic diagram of a first time unit set and a second time unit set, as shown in FIG. 10A. In FIG. 10A, the second signaling is used to activate an SPS configuration, the first node receives Q downlink assignments before the SPS configuration is released, the Q downlink assignments respectively correspond to Q PDSCHs, the Q PDSCHs are respectively transmitted in Q time units, Q being a positive integer greater than Y, and the Y-th downlink assignment is a Y-th time unit among the Q time units. As shown in the figure, the Q time units are divided into a first time unit set and a second time unit set, the first time unit set consists of first 0.5*Q time unit(s) among the Q time units, and the second time unit set consists of last 0.5*Q time unit(s) among the Q time units.

In one embodiment, when a Y-th time unit belongs to the first time unit set, the first signal adopts a first MCS; when a Y-th time unit belongs to the second time unit set, the first signal adopts a second MCS; the first MCS is different from the second MCS.

In one embodiment, when a Y-th time unit belongs to the first time unit set, a number of REs occupied by the first signal is equal to X1; when a Y-th time unit belongs to the second time unit set, a number of REs occupied by the first signal is equal to X2; X1 is different from X2, and both X1 and X2 are positive integers greater than 1.

In one embodiment, when a Y-th time unit belongs to the first time unit set, a number of RB(s) occupied by the first signal is equal to a first integer; when a Y-th time unit belongs to the second time unit set, a number of RB(s) occupied by the first signal is equal to a second integer; the first integer is different from the second integer, and the first integer and the second integer are both positive integers.

### Embodiment 10B

Embodiment 10B illustrates a schematic diagram of a first time unit set and a second time unit set, as shown in FIG. 10B. In FIG. 10B, the first signaling is used to configure a configured grant, the first node receives P uplink grants before the configured grant is released, the P uplink grants respectively correspond to P PUSCHs, the P PUSCHs are respectively transmitted in P time units, P being a positive integer greater than Y, and the Y-th uplink grant is a Y-th time unit among the P time units. As shown in the figure, the P time units are divided into a first time unit set and a second time unit set, the first time unit set consists of time unit(s) with a sequence number of (2*i−1) among the P time units, and the second time unit set consists of time unit(s) with a sequence number of (2*i) among the P time units; i is a smallest positive integer greater than 0 and not less than 0.5*P.

In one embodiment, when a Y-th time unit belongs to the first time unit set, the first signal adopts a first MCS; when a Y-th time unit belongs to the second time unit set, the first signal adopts a second MCS; the first MCS is different from the second MCS.

In one embodiment, when a Y-th time unit belongs to the first time unit set, a number of REs occupied by the first signal is equal to X1; when a Y-th time unit belongs to the second time unit set, a number of REs occupied by the first signal is equal to X2; X1 is different from X2, and both X1 and X2 are positive integers greater than 1.

In one embodiment, when a Y-th time unit belongs to the first time unit set, a number of RB(s) occupied by the first signal is equal to a first integer; when a Y-th time unit belongs to the second time unit set, a number of RB(s) occupied by the first signal is equal to a second integer; the first integer is different from the second integer, and the first integer and the second integer are both positive integers.

### Embodiment 11A

Embodiment 11A illustrates a structure block diagram in a first node, as shown in FIG. 11A. In FIG. 11A, a first node 1100A comprises a first receiver 1101A and a second receiver 1102A.

The first receiver 1101A receives a first signaling and a second signaling, the first signaling is used to indicate an SPS configuration, and the second signaling is used to provide a downlink assignment for the SPS configuration;
the second receiver 1102A receives a first signal in a first time unit;
In embodiment 11A, the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the second signaling is used to indicate an SPS activation; the second signaling is used to determine frequency-domain resources occupied by the first signal.

In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, at least one of coding rate adopted by the channel coding to which the first bit block is subjected or a modulation order adopted by the modulation to which the first bit block is subjected is related to the Y.

In one embodiment, the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

In one embodiment, the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, the first signaling is used to determine at least one of the first time unit set or the second time unit set.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, the first receiver 1101A comprises at least first four of the antenna 452, the receiver 454, the multi-antenna receiving processor 458, the receiving processor 456 and the controller/processor 459 in Embodiment 4.

In one embodiment, the second receiver 1102A comprises at least first four of the antenna 452, the receiver 454, the multi-antenna receiving processor 458, the receiving processor 456 and the controller/processor 459 in Embodiment 4.

In one embodiment, the first signaling is an RRC signaling, the second signaling is a PDCCH, the first signal is a PDSCH, the second signaling is used to activate an SPS configuration, the first signal is obtained by a first bit block through at least channel coding and modulation, and the first signal is a PDSCH corresponding to a Y-th downlink assignment after the SPS configuration is activated; the first signal is obtained after a first bit block is subjected to at least channel coding and modulation; a TBS comprised in the first bit block is related to Y.

### Embodiment 11B

Embodiment 11B illustrates a schematic diagram of a first time unit set and a second time unit set, as shown in FIG. 11B. In FIG. 11B, the first signaling is used to configure a configured grant, the first node receives Q uplink grants before the configured grant is released, the Q uplink grants respectively correspond to Q PUSCHs, the Q PDSCHs are respectively transmitted in Q time units, Q being a positive integer greater than Y, and the Y-th uplink grant is a Y-th time unit in the Q time units. As shown in the figure, the Q time units are divided into a first time unit set and a second time unit set, the first time unit set consists of first 0.5*Q time unit(s) among the Q time units, and the second time unit set consists of last 0.5*Q time unit(s) among the Q time units.

In one embodiment, when a Y-th time unit belongs to the first time unit set, the first signal adopts a first MCS; when a Y-th time unit belongs to the second time unit set, the first signal adopts a second MCS; the first MCS is different from the second MCS.

In one embodiment, when a Y-th time unit belongs to the first time unit set, a number of REs occupied by the first signal is equal to X1; when a Y-th time unit belongs to the second time unit set, a number of REs occupied by the first signal is equal to X2; X1 is different from X2, and both X1 and X2 are positive integers greater than 1.

In one embodiment, when a Y-th time unit belongs to the first time unit set, a number of RB(s) occupied by the first signal is equal to a first integer; when a Y-th time unit belongs to the second time unit set, a number of RB(s) occupied by the first signal is equal to a second integer; the first integer is different from the second integer, and the first integer and the second integer are both positive integers.

### Embodiment 12A

Embodiment 12A illustrates a structure block diagram of in a second node, as shown in FIG. 12A. In FIG. 12A, a second node 1200A comprises a first transmitter 1201A and a second transmitter 1202A.

The first transmitter 1201A transmits a first signaling and a second signaling, the first signaling is used to indicate an SPS configuration, the second signaling is used to provide a downlink assignment for the SPS configuration;
the second transmitter 1202A transmits a first signal in a first time unit;
In embodiment 12A, the first time unit is occupied by a Y-th downlink assignment after the downlink assignment is configured; the first signal is obtained after a first bit block is subjected to at least channel coding and modulation; a number of bit(s) comprised in the first bit block is related to the Y.

In one embodiment, the second signaling is used to indicate an SPS activation; the second signaling is used to determine frequency-domain resources occupied by the first signal.

In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, at least one of coding rate adopted by the channel coding to which the first bit block is subjected or a modulation order adopted by the modulation to which the first bit block is subjected is related to the Y.

In one embodiment, the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

In one embodiment, the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, the first signaling is used to determine at least one of the first time unit set or the second time unit set.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, the first transmitter 1201A comprises at least first four of the antenna 420, the transmitter 418, the multi-antenna transmitting processor 471, the transmitting processor 414 and the controller/processor 475 in Embodiment 4.

In one embodiment, the second transmitter 1202A comprises at least first four of the antenna 420, the transmitter 418, the multi-antenna transmitting processor 471, the transmitting processor 414 and the controller/processor 475 in embodiment 4.

In one embodiment, the first signaling is an RRC signaling, the second signaling is a PDCCH, the first signal is a PDSCH, the second signaling is used to activate an SPS configuration, the first signal is obtained by a first bit block through at least channel coding and modulation, and the first signal is a PDSCH corresponding to a Y-th downlink assignment after the SPS configuration is activated; the first signal is obtained after a first bit block is subjected to at least channel coding and modulation; a TBS comprised in the first bit block is related to Y.

### Embodiment 12B

Embodiment 12B illustrates a structure block diagram in a first node, as shown in FIG. 12B. In FIG. 12B, a processor 1200B of a first node comprises a first receiver 1201B and a first transmitter 1202B.

The first receiver 1201B receives a first signaling, and the first signaling is used to indicate a configuration of configured grant;
the first transmitter 1202B transmits a first signal in a first time unit;
In embodiment 12B, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the first receiver 1201 receives a second signaling; a CRC comprised in the second signaling is scrambled through a first RNTI; the second signaling is used to indicate that the configured grant indicated by the first signaling is activated; the second signaling is a physical-layer signaling; the first RNTI is an RNTI other than a C-RNTI.

In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, at least one of coding rate adopted by the channel coding to which the first bit block is subjected or a modulation order adopted by the modulation to which the first bit block is subjected is related to the Y.

In one embodiment, the first signaling is used to determine a first MCS table and the second signaling is used to indicate a target MCS index from the first MCS table, or the first signaling is used to indicate a target MCS index; the target MCS index and Y are used together to determine at least one of coding rate adopted by the channel coding to which the first bit block is subjected or a modulation order adopted by the modulation to which the first bit block is subjected.

In one embodiment, the first signaling is used to indicate a first configured grant configuration index, and a period of a configured grant corresponding to the first configured grant configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, the first signaling is used to determine at least one of the first time unit set or the second time unit set.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, the first receiver 1201B comprises at least first four of the antenna 452, the receiver 454, the multi-antenna receiving processor 458, the receiving processor 456 and the controller/processor 459 in Embodiment 4.

In one embodiment, the first transmitter 1202B comprises at least the first four of the antenna 452, the transmitter 454, the multi-antenna transmitting processor 457, the transmitting processor 468 and the controller/processor 459 in embodiment 4.

In one embodiment, the first signaling is an RRC signaling, and the first signal is a PUSCH, and the first signaling is used to indicate configuration information of the configured grant; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the first signaling is an RRC signaling, and the first signal is a PUSCH, and the first signaling is used to indicate configuration information of the configured grant; the first signal is obtained after a first bit block is subjected to at least channel coding and modulation; a number of RE(s) occupied by the first signal is related to the Y; the first signaling is an RRC signaling, and the first signaling is used to indicate a number of HARQ process(es) of the configured grant; Y is a positive integer.

In one embodiment, the first signaling is an RRC signaling, and the first signal is a PUSCH, and the first signaling is used to indicate configuration information of the configured grant; the first signal is obtained after a first bit block is subjected to at least channel coding and modulation; a number of RB(s) occupied by the first signal is related to Y; the first signaling is an RRC signaling, and the first signaling is used to indicate a number of HARQ process(es) of the configured grant; Y is a positive integer.

In one embodiment, the first signaling is an RRC signaling, and the first signal is a PUSCH, and the first signaling is used to indicate configuration information of the configured grant; the first signal is obtained after a first bit block is subjected to at least channel coding and modulation; an MCS adopted by the first signal is related to Y; the first signaling is an RRC signaling, and the first signaling is used to indicate a number of HARQ process(es) of the configured grant; Y is a positive integer.

In one embodiment, the first signaling is an RRC signaling, the second signaling is a PDCCH, the first signal is a PUSCH, and the first signaling is used to indicate configuration information of the configured grant; the second signaling used to activate the first signaling is used to indicate the configured grant, and the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the first signaling is an RRC signaling, the second signaling is a PDCCH, the first signal is a PUSCH, and the first signaling is used to indicate configuration information of the configured grant; the second signaling used to activate the first signaling is used to indicate the configured grant, and the first signal is obtained after a first bit block is subjected to at least channel coding and modulation; a number of RE(s) occupied by the first signal is related to the Y; the first signaling is an RRC signaling, and the first signaling is used to indicate a number of HARQ process(es) of the configured grant; Y is a positive integer.

In one embodiment, the first signaling is an RRC signaling, the second signaling is a PDCCH, the first signal is a PUSCH, and the first signaling is used to indicate configuration information of the configured grant; the second signaling used to activate the first signaling is used to indicate the configured grant, and the first signal is obtained after a first bit block is subjected to at least channel coding and modulation; a number of RB(s) occupied by the first signal is related to Y; the first signaling is an RRC signaling, and the first signaling is used to indicate a number of HARQ process(es) of the configured grant; Y is a positive integer.

In one embodiment, the first signaling is an RRC signaling, the second signaling is a PDCCH, the first signal is a PUSCH, and the first signaling is used to indicate configuration information of the configured grant; the second signaling used to activate the first signaling is used to indicate the configured grant, and the first signal is obtained after a first bit block is subjected to at least channel coding and modulation; an MCS adopted by the first signal is related to Y; the first signaling is an RRC signaling, and the first signaling is used to indicate a number of HARQ process(es) of the configured grant; Y is a positive integer.

### Embodiment 13

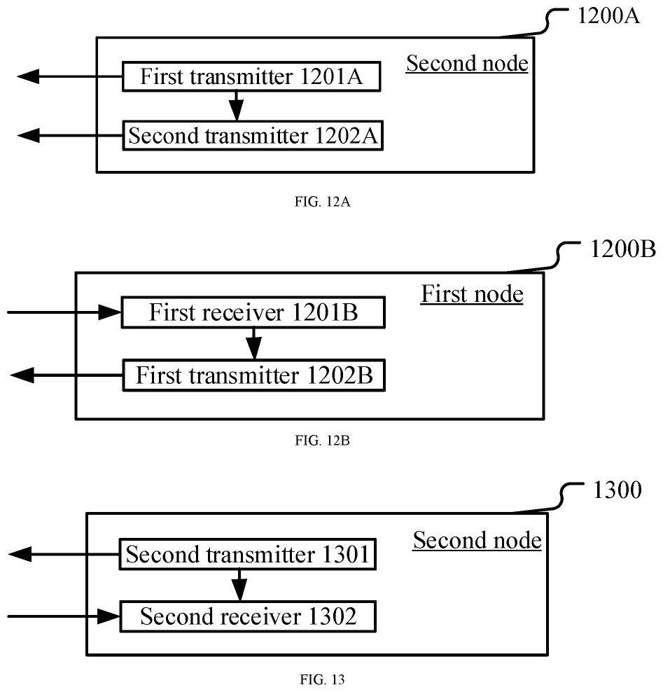

Embodiment 13 illustrates a structure block diagram of in a second node, as shown in FIG. 13. In FIG. 13, a second node 1300 comprises a second transmitter 1301 and a second receiver 1302.

The second transmitter 1301 transmits a first signaling, the first signaling is used to indicate a configuration of configured grant;
the second receiver 1302 receives a first signal in a first time unit;
In embodiment 13, the first time unit is occupied by a given uplink grant, the given uplink grant is a Y-th uplink grant after the configured grant indicated by the first signaling is configured; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the second transmitter 1301 transmits a second signaling; a CRC comprised in the second signaling is scrambled through a first RNTI; the second signaling is used to indicate that the configured grant indicated by the first signaling is activated; the second signaling is a physical-layer signaling; the first RNTI is an RNTI other than a C-RNTI;
In one embodiment, coding rate adopted by the channel coding to which the first bit block is subjected and a modulation order adopted by the modulation to which the first bit block is subjected are unrelated to Y; a number of RE(s) occupied by the first signal is related to the Y.

In one embodiment, at least one of coding rate adopted by the channel coding to which the first bit block is subjected or a modulation order adopted by the modulation to which the first bit block is subjected is related to the Y.

In one embodiment, the first signaling is used to determine a first MCS table and the second signaling is used to indicate a target MCS index from the first MCS table, or the first signaling is used to indicate a target MCS index; the target MCS index and Y are used together to determine at least one of coding rate adopted by the channel coding to which the first bit block is subjected or a modulation order adopted by the modulation to which the first bit block is subjected.

In one embodiment, the first signaling is used to indicate a first configured grant configuration index, and a period of a configured grant corresponding to the first configured grant configuration index is used to determine a first time unit set and a second time unit set; both the first time unit set and the second time unit set comprise positive integer number of time units greater than 1; the first time unit set comprises the first time unit or the second time unit set comprises the first time unit.

In one embodiment, the first signaling is used to determine at least one of the first time unit set or the second time unit set.

In one embodiment, the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

In one embodiment, the first transmitter 1301B comprises at least first four of the antenna 420, the transmitter 418, the multi-antenna transmitting processor 471, the transmitting processor 414 and the controller/processor 475 in embodiment 4.

In one embodiment, the second receiver 1302B comprises at least the first four of the antenna 420, the receiver 418, the multi-antenna receiving processor 472, the receiving processor 470 and the controller/processor 475 in embodiment 4.

In one embodiment, the first signaling is an RRC signaling, and the first signal is a PUSCH, and the first signaling is used to indicate configuration information of the configured grant; the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

In one embodiment, the first signaling is an RRC signaling, the second signaling is a PDCCH, the first signal is a PUSCH, and the first signaling is used to indicate configuration information of the configured grant; the second signaling used to activate the first signaling is used to indicate the configured grant, and the first signal is obtained after a first bit block is subjected to at least channel coding and modulation; a number of bit(s) comprised in the first bit block is related to the Y; the first signaling is an RRC signaling, and the first signaling is used to indicate a number of HARQ process(es) of the configured grant; Y is a positive integer.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, tele-controlled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling, the first signaling being used to indicate an SPS configuration, the second signaling being used to provide a downlink assignment for the SPS configuration; and
the second receiver, receiving a first signal in a first time unit;
wherein the first time unit is occupied by a Y-th downlink assignment after the downlink assignment is configured;
the first signal is obtained after a first bit block is subjected to at least channel coding and modulation; a number of bit(s) comprised in the first bit block is related to the Y.

2. The first node according to claim 1, wherein the second signaling is used to indicate an SPS activation; the second signaling is used to determine frequency-domain resources occupied by the first signal.

3. The first node according to claim 1, wherein coding rate adopted by the channel coding to which the first bit block is subjected and a modulation order adopted by the modulation to which the first bit block is subjected are unrelated to Y; a number of RE(s) occupied by the first signal is related to the Y.

4. The first node according to claim 1, wherein at least one of coding rate adopted by the channel coding to which the first bit block is subjected or a modulation order adopted by the modulation to which the first bit block is subjected is related to the Y.

5. The first node according to claim 4, wherein the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

6. The first node according to claim 5, wherein the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

7. The first node according to claim 6, wherein the first signaling is used to determine at least one of the first time unit set or the second time unit set.

8. The first node according to claim 1, wherein the first signal is for a first service type, and a period of the first service type is equal to M1 milliseconds, M1 being a real number greater than 1, and coding rate adopted by the channel coding to which the first bit block is subjected and a modulation order adopted by the modulation to which the first bit block is subjected is a first MCS index or a second MCS index; a value of M1 is used to determine a difference value between the first MCS index and the second MCS index.

9. The first node according to claim 1, wherein a Frequency Domain Assignment field comprised in the second signaling is used to determine a frequency-domain location of an RB occupied by the first signal; a Frequency Domain Assignment field comprised in the second signaling is used to indicate a first RB set, the first RB set comprises a positive integer number of RBs greater than one, frequency-domain resources occupied by the first signal comprises at least the first RB set in the first RB set or a second RB set, the second RB set comprises a positive integer number of RBs greater than one, and a frequency-domain location of the first RB set is used to determine a frequency-domain location of the second RB set; whether frequency-domain resources occupied by the first signal comprise the second RB set is related to a value of Y.

10. The first node according to claim 1, wherein the first signal is for a first service type, and a period of the first service type is equal to M1 milliseconds, M1 being a real number greater than 1, and a number of RB(s) occupied by the first signal is equal to a first integer or a second integer; the first integer is not equal to the second integer; the first integer and the second integer are both positive integers; a value of M1 is used to determine a ratio of the first integer to the second integer.

11. The first node according to claim 1, wherein the first signal is for a first service type, and a period of the first service type is equal to M1 milliseconds, M1 being a real number greater than 1, and a number of RE(s) occupied by the first signal is equal to a third integer or a fourth integer; the third integer is not equal to the fourth integer; the third integer and the fourth integer are both positive integers greater than 1; a value of M1 is used to determine a ratio of the third integer to the fourth integer.

12. The first node according to claim 6, wherein the first signal is for a first service type, a period of the first service type is equal to M1 milliseconds, M1 being a real number greater than 1, and a value of the M1 is used to determine a ratio of a number of time unit(s) comprised in the first time unit set to a number of time unit(s) comprised in the second time unit set.

13. A second node for wireless communications, comprising:
a first transmitter, transmitting a first signaling and a second signaling, the first signaling being used to indicate an SPS configuration, the second signaling being used to provide a downlink assignment for the SPS configuration; and
a second transmitter, transmitting a first signal in a first time unit;
wherein the first time unit is occupied by a Y-th downlink assignment after the downlink assignment is configured;
the first signal is obtained after a first bit block is subjected to at least channel coding and modulation; a number of bit(s) comprised in the first bit block is related to the Y.

14. The second node according to claim 13, wherein the second signaling is used to indicate an SPS activation; the second signaling is used to determine frequency-domain resources occupied by the first signal.

15. The second node according to claim 13, wherein coding rate adopted by the channel coding to which the first bit block is subjected and a modulation order adopted by the modulation to which the first bit block is subjected are unrelated to Y; a number of RE(s) occupied by the first signal is related to the Y.

16. The second node according to claim 13, wherein at least one of coding rate adopted by the channel coding to which the first bit block is subjected or a modulation order adopted by the modulation to which the first bit block is subjected is related to the Y.

17. The second node according to claim 16, wherein the first signaling is used to determine a first MCS table, the second signaling is used to indicate the target MCS index from the first MCS table, and the target MCS index and Y are used together to determine at least one of coding rate adopted by the channel coding to which the first bit block is subjected or a modulation order adopted by the modulation to which the first bit block is subjected.

18. The second node according to claim 17, wherein the first signaling is used to indicate a first SPS configuration index, and a period of an SPS configuration corresponding to the first SPS configuration index is used to determine a first time unit set and a second time unit set; both the first time unit set and the second time unit set comprise positive integer number of time units greater than 1; the first time unit set comprises the first time unit or the second time unit set comprises the first time unit.

19. The second node according to claim 16, wherein the first signaling is used to determine at least one of the first time unit set or the second time unit set.

20. A method in a first node for wireless communications, comprising:
receiving a first signaling and a second signaling, the first signaling being used to indicate an SPS configuration, the second signaling being used to provide a downlink assignment for the SPS configuration; and
receiving a first signal in a first time unit;
wherein the first time unit is occupied by a Y-th downlink assignment after the downlink assignment is configured;
the first signal is obtained after a first bit block is subjected to at least channel coding and modulation; a number of bit(s) comprised in the first bit block is related to the Y.
